(19) United States
(12) Patent Application Publication
(10) Pub. No.: US 2001/0047313 A1
(43) Pub. Date: Nov. 29, 2001

(54) Method and system for electronic commerce using transaction management computer on network

(75) Inventor: Tatsunori Kanai, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/864,337

(22) Filed: May 25, 2001

(30) Foreign Application Priority Data
May 26, 2000 (JP) 2000-157014

(51) Int. Cl. G06F 17/60

(52) U.S. Cl. 705/26

(57) ABSTRACT

The electronic commerce between a plurality of shop computers providing electronic shops on a network and a plurality of client computers used by users utilizing the electronic shops, is realized by using a transaction management computer provided on the network, which manages transaction information for each transaction currently in progress between one electronic shop among the plurality of electronic shops and one user among the plurality of users, and processes each transaction according to the managed transaction information.

### BACKGROUND OF THE INVENTION

1. Field Of The Invention

The present invention relates to method and system for realizing electronic commerce on a network such as the Internet.

2. Description of the Related Art

Many of the electronic shopping system or electronic commerce system on the Internet are constructed on a basis of the WWW (World Wide Web) system. On a client computer to be used by a customer who wishes to make purchases or reservations at an electronic shop, a software called WEB browser (or simply browser) is operated. The customer makes an access from the WEB browser through the Internet to a shop computer of the electronic shop from which the customer wishes to make purchases or reservations, and carries out the product information viewing or the product purchasing procedure.

On the shop computer, a program for realizing functions of the electronic shop is operated, which carries out the sales processing including a presentation of a product description and a price to the customer, an inventory check in response to an order from the customer, a payment processing, and a delivery arrangement. There are also cases where the shop computer provides services such as the discount sale or the product recommendation suitable for the customer by managing the past transaction logs of the customer. The shop computer may also carry out communications with a computer of the other service company at a time of the payment by a credit card, for example.

The WEB browser on the client computer and the electronic shop program on the shop computer carry out communications using the standard communication protocol of the WWW called HTTP. The HTTP is a protocol in which a set of request and reply forms a basic unit of communication such that when a processing request identifier called URL and any necessary information associated with that request are sent as a request, data of an HTML document or the like that indicates the processing result will be returned. In the electronic commerce, the request is sent from the client computer toward the shop computer, and the reply is sent from the shop computer toward the client computer.

Usually, plural sets of request and reply are necessary since the start until the end of the so called electronic commerce procedure on the Internet. In the case of the book sales, for example, the following series of request and reply sets are required to be exchanged between the WEB browser on the client computer and the electronic shop program on the shop computer.

(1) A title of a desired book is sent as a request.

(2) Information on inventory and price is returned as a reply.

(3) A consent to purchase is sent as a request.

(4) An input form for information regarding payment and delivery is returned as a reply.

(5) The input form with the necessary information filled in is sent as a request.

(6) A notice for completion of the procedure is returned as a reply.

Such a processing sequence for a series of request and reply sets that are required for one processing is called a session. The HTTP itself is not provided with any means for managing sessions. Namely, the electronic shop program on the shop computer executes the transaction processings with respect to a plurality of customers in parallel. However, when the electronic shop program on the shop computer receives the request (5) indicating the information necessary for the purpose in the above example from some customer, the HTTP is not provided with any means for judge which customer is sending this request (5) in response to which reply (4). For this reason, the session is usually managed by using a mechanism called COOKIE as disclosed in “RFC 2109: HTTP State Management Mechanism”, for example. The electronic shop program on the shop computer relates a plurality of requests and replies that constitute the session by using a character string for identification purpose called COOKIE.

Many of the electronic shop programs on the shop computers also have a shopping cart function. In the shopping cart function, the customer is usually allowed to put products selected at that electronic shop into the shopping cart or take out products in the shopping cart to return them freely, and the customer can carry out the purchasing procedure collectively for a plurality of products in the shopping cart by pressing “purchase button”, “decision button” or “settlement button” at the end, for example (and often the payment procedure is also carried out at this point collectively for a plurality of products by entering the credit card number, for example). The known methods for realizing the shopping cart function include a method for recording the products selected by each customer at the shop computer side, and a method for recording the products selected by the customer at the customer's own client computer side.

In the following, the problems associated with the conventional electronic commerce system will be described.

The first problem of the electronic commerce system on the Internet is that both the customer and the shop have no means for checking whether the transaction session currently in progress is progressing properly or some error has occurred, because the session between the client computer of the customer and the shop computer of the electronic shop is managed using the HTTP and COOKIE mechanism.

For example, suppose that the customer who is trying to purchase some product has pressed a “pay” button by entering the credit card number necessary for the payment and the delivery destination from the WEB browser on the client computer. Usually, in response to this, a request for starting the payment procedure will be sent to the shop computer, the appropriate processing will be executed there, and a message notifying the completion of the payment procedure will be returned as a reply.

However, when the reply is not returned even after a considerable time since the pressing of the “pay” button, the customer cannot judge if the request has failed to reach the shop computer, or the shop computer has been disabled, or the payment procedure was completed but the reply has fails to reach the client computer, or simply the payment procedure is not yet completed because of the heavy loads so that everything is normal. The customer also cannot decide whether or not the “pay” button should be pressed again because the customer does not know whether that will cause double orders or an error, and the customer also cannot finish the transaction without knowing whether the payment procedure is completed or not.

The similar problem also exists for the electronic shop program on the shop computer. For example, suppose the request for the purchase of some product is received from the customer and the reply for urging the input of the payment method and the delivery destination is returned after checking the inventory of that product. Usually, in response to this, the input form with the payment method and the delivery destination filled in will be returned as a request after awhile.

However, when the request is not returned even after a considerable time, the electronic shop program on the shop computer cannot judge if the reply has failed to reach the client computer, or the client computer has been disabled, or the request using the input form has failed to reach the shop computer, or the customer has changed his/her mind and put the transaction aside, or simply the customer is taking a considerable time in filling the input form and everything is normal. The shop cannot release the secured stock because the customer might still have the intention to purchase, but on the contrary, the customer might have already lost the intention to purchase so that keeping of the secured stock is useless.

The second problem of the electronic commerce system on the Internet is that, when an error or a situation that might be caused by an error has occurred during the transaction session currently in progress, both the customer and the shop have no unified way for resuming that session properly to continue that transaction or for interrupting that session properly to cancel the transactions made up to that point. At present, the customer or the shop has no choice but discarding the session one-sidedly.

In order to deal with such a situation, it is possible to consider the measure for providing a function to invalidate the transaction currently in progress on the electronic shop program on the shop computer. However, this method is possible only in the case where the client computer can be re-connected to the shop computer, so that there is a need for the client computer to memorize the address (URL) of the shop with which the transaction has been carried out, and this method cannot deal with the fault on the shop computer side.

Thus there is a need for a unified method to continue or interrupt the transaction properly by the same procedure regardless of the electronic shop involved in the transaction when an error or a situation that might be caused by an error has occurred during the transaction, on both sides of the customer and the shop that carry out the electronic commerce on the Internet.

The third problem of the electronic commerce system on the Internet is that there is no shopping cart function that enables the collective commitment for a plurality of purchases made at a plurality of different electronic shops.

The shopping cart function that enables the collective commitment for a plurality of products within the same electronic shop is widely used. The shopping cart function that can handle products of a plurality of electronic shops within the same electronic shopping mall is also available. However, these existing shopping cart functions cannot enable the collective commitment of purchases made at a plurality of different electronic shops.

For example, in the case of trying to reserve a room of the hotel “A” and an airline ticket of the airline company “B” as a preparation of the travel, one is willing to make purchases of both if both of them can be reserved, but one is not willing to make purchase of either one if either one of them cannot be reserved. This type of purchasing can be supported in the currently existing electronic commerce system on the Internet, only if the hotel “A” and the airline company “B” have their shops in the same shopping mall and that shopping mall provides the shopping cart that can handle products of a plurality of shops within that shopping mall.

Apart from the above described case of mutually dependent purchases, if the shopping cart function that can handle purchases made at a plurality of different electronic shops collectively is available, the procedure necessary for the payment can be completed collectively so that it can be quite convenient.

The fourth problem of the electronic commerce system on the Internet is that there is no means for realizing the centralized management of the past transaction logs and states of the transactions currently in progress.

In the case of telephones, the telephone station manages records so that one can obtain the record of phone calls made by oneself upon request. Also, in the case of credit cards, the credit card company maintains the records so that one can obtain the record of credit card uses made by oneself. However, in the case of the electronic commerce on the Internet, there is no service that provides such a centralized management of records.

For example, there can be cases where one wishes to check what items have been bought at which electronic shops in the past, or cases where one wishes to check items in the shopping cart that have not been committed, or cases where one wishes to know the current states of the ordered items, but in any of these cases there is no available function for automatically acquiring the record that one can refer. Currently such a record of the past transactions must be managed by the customer himself/herself voluntarily.

As described, the conventional electronic commerce system have been associated with various problems including inability to detect the session error, lack of a unified way to resume or interrupt the session in the case where a fault occurs during the session, lack of a shopping cart function that can be used across different electronic shops, and lack of a management function for transaction logs across different electronic shops.

### BRIEF SUMMARY OF THE INVENTION

It is therefore an object of the present invention to provide method and system for electronic commerce that are capable of enabling the fault detection, the fault handling, and the recovery from the fault effectively, and realizing a global shopping cart function that can be used across different electronic shops and a centralized management function for transaction logs across different electronic shops.

According to one aspect of the present invention there is provided a transaction management device, connected through a network with a plurality of shop computers providing electronic shops on the network and a plurality of client computers used by users utilizing the electronic shops, the transaction management device comprising: a management unit configured to manage transaction information for each transaction currently in progress between one electronic shop among the plurality of electronic shops and one user among the plurality of users, the transaction information containing a set of: a first information for identifying said each transaction; a second information for identifying said one user; a third information for identifying said one electronic shop; and a fourth information for indicating a state of said each transaction as one of a plurality of possible states including a first state in which a command for finalizing completion or failure of transaction is waited, a second state in which a command for finalizing completion of transaction is received and a processing for finalizing completion of transaction is started but not finished yet, a third state in which the processing for finalizing completion of transaction is finished, and a fourth state in which failure of transaction is already finalized; and a processing unit configured to process said each transaction according to the transaction information managed by the management unit.

According to another aspect of the present invention there is provided a method for realizing electronic commerce between a plurality of shop computers providing electronic shops on a network and a plurality of client computers used by users utilizing the electronic shops, comprising: managing transaction information for each transaction currently in progress between one electronic shop among the plurality of electronic shops and one user among the plurality of users, at a transaction management computer, the transaction information containing a set of: a first information for identifying said each transaction; a second information for identifying said one user; a third information for identifying said one electronic shop; and a fourth information for indicating a state of said each transaction as one of a plurality of possible states including a first state in which a command for finalizing completion or failure of transaction is waited, a second state in which a command for finalizing completion of transaction is received and a processing for finalizing completion of transaction is started but not finished yet, a third state in which the processing for finalizing completion of transaction is finished, and a fourth state in which failure of transaction is already finalized; and processing said each transaction according to the transaction information managed by the managing step, at the transaction management computer.

According to another aspect of the present invention there is provided a computer usable medium having computer readable program codes embodied therein for causing a computer to function as a transaction management computer, the computer readable program codes include: a first computer readable program code for causing said computer to manage transaction information for each transaction currently in progress between one electronic shop among the plurality of electronic shops and one user among the plurality of users, the transaction information containing a set of: a first information for identifying said each transaction; a second information for identifying said one user; a third information for identifying said one electronic shop; and a fourth information for indicating a state of said each transaction as one of a plurality of possible states including a first state in which a command for finalizing completion or failure of transaction is waited, a second state in which a command for finalizing completion of transaction is received and a processing for finalizing completion of transaction is started but not finished yet, a third state in which the processing for finalizing completion of transaction is finished, and a fourth state in which failure of transaction is already finalized; and a second computer readable program code for causing said computer to process said each transaction according to the transaction information managed by the first computer readable program code.

Other features and advantages of the present invention will become apparent from the following description taken in conjunction with the accompanying drawings.

### BRIEF DESCRIPTION OF THE DRAWINGS

FIG. 1 is a schematic diagram showing an exemplary configuration of an electronic commerce system according to one embodiment of the present invention.

FIG. 2 is a block diagram showing an exemplary configuration of a transaction management computer in the electronic commerce system of FIG. 1.

FIG. 3 is a schematic diagram showing a concrete example of the electronic commerce system according to one embodiment of the present invention.

FIG. 4 is a sequence chart showing one part of an exemplary operation procedure in the concrete example shown in FIG. 3.

FIG. 5 is a diagram showing an exemplary home page of one shop computer as displayed at a client computer in the concrete example shown in FIG. 3.

FIG. 6 is a diagram showing an exemplary reservation page of one shop computer as displayed at a client computer in the concrete example shown in FIG. 3.

FIG. 7 is a diagram showing the exemplary reservation page of FIG. 6 with user input entered.

FIG. 8 is a diagram showing an exemplary reservation confirmation page of one shop computer as displayed at a client computer in the concrete example shown in FIG. 3.

FIG. 9 is a diagram showing an exemplary transaction information managed by a transaction information database at one stage in the concrete example shown in FIG. 3.

FIG. 10 is a diagram showing an exemplary user authentication page of a transaction management computer as displayed at a client computer in the concrete example of FIG. 3.

FIG. 11 is a diagram showing the exemplary user authentication page of FIG. 10 with user input entered.

FIG. 12 is a diagram showing an exemplary personal information managed by a personal information database in the concrete example shown in FIG. 3.

FIG. 13 is a diagram showing an exemplary transaction information managed by a transaction information database at another stage in the concrete example shown in FIG. 3.

FIG. 14 is a diagram showing an exemplary shopping cart page of a transaction management computer at one stage as displayed at a client computer in the concrete example of FIG. 3.

FIG. 15 is a sequence chart showing another part of an exemplary operation procedure in the concrete example shown in FIG. 3.

FIG. 16 is a diagram showing an exemplary reservation page of another shop computer as displayed at a client computer in the concrete example shown in FIG. 3.

FIG. 17 is a diagram showing the exemplary reservation page of FIG. 16 at one stage with user input entered.

FIG. 18 is a diagram showing an exemplary seat availability status page of another shop computer at one stage as displayed at a client computer in the concrete example shown in FIG. 3.

FIG. 19 is a diagram showing an exemplary reservation confirmation page of another shop computer at one stage as displayed at a client computer in the concrete example shown in FIG. 3.

FIG. 20 is a diagram showing an exemplary reservation page of another shop computer at another stage as displayed at a client computer in the concrete example shown in FIG. 3.

FIG. 21 is a diagram showing the exemplary reservation page of FIG. 16 at another stage with user input entered.

FIG. 22 is a diagram showing an exemplary seat availability status page of another shop computer at another stage as displayed at a client computer in the concrete example shown in FIG. 3.

FIG. 23 is a diagram showing an exemplary reservation confirmation page of another shop computer at another stage as displayed at a client computer in the concrete example shown in FIG. 3.

FIG. 24 is a diagram showing an exemplary transaction information managed by a transaction information database at another stage in the concrete example shown in FIG. 3.

FIG. 25 is a diagram showing an exemplary shopping cart page of a transaction management computer at another stage as displayed at a client computer in the concrete example of FIG. 3.

FIG. 26 is a sequence chart showing another part of an exemplary operation procedure in the concrete example shown in FIG. 3.

FIG. 27 is a diagram showing an exemplary state transition of transactions managed by a transaction management computer during the operation procedure of FIG. 26.

FIG. 28 is a diagram showing an exemplary transaction information managed by a transaction information database at another stage in the concrete example shown in FIG. 3.

FIG. 29 is a diagram showing an exemplary transaction information managed by a transaction information database at another stage in the concrete example shown in FIG. 3.

FIG. 30 is a diagram showing an exemplary shopping cart page of a transaction management computer at another stage as displayed at a client computer in the concrete example of FIG. 3.

FIG. 31 is a sequence chart showing another part of an exemplary operation procedure in the concrete example shown in FIG. 3.

FIG. 32 is a diagram showing an exemplary state transition of transactions managed by a transaction management computer during the operation procedure of FIG. 31.

FIG. 33 is a diagram showing an exemplary display containing a shopping window of a shop computer and a shopping cart window of a transaction management computer as displayed at a client computer in the concrete example of FIG. 3.

FIG. 34 is a diagram showing an exemplary shopping cart page of a transaction management computer at another stage as displayed at a client computer in the concrete example of FIG. 3.

FIG. 35 is a diagram showing an exemplary shopping cart page of a transaction management computer at another stage as displayed at a client computer in the concrete example of FIG. 3.

FIG. 36 is a flow chart showing an exemplary processing procedure of a transaction management computer in the electronic commerce system of FIG. 1 with respect to a shopping cart page request from a client computer.

FIG. 37 is a flow chart showing an exemplary processing procedure of a transaction management computer in the electronic commerce system of FIG. 1 with respect to a collective processing request from a client computer.

FIG. 38 is a flow chart showing an exemplary processing procedure of a transaction management computer in the electronic commerce system of FIG. 1 with respect to a cancellation request from a client computer.

FIG. 39 is a flow chart showing an exemplary processing procedure of a fault recovery processing by a transaction management computer in the electronic commerce system of FIG. 1.

FIG. 40 is a flow chart showing an exemplary processing procedure of a shop computer in the electronic commerce system of FIG. 1 with respect to a TMS registration request from a client computer.

FIG. 41 is a flow chart showing an exemplary processing procedure of a shop computer in the electronic commerce system of FIG. 1 with respect to a PREPARE processing request from a transaction management computer.

FIG. 42 is a flow chart showing an exemplary processing procedure of a shop computer in the electronic commerce system of FIG. 1 with respect to a COMMIT processing request from a transaction management computer.

FIG. 43 is a flow chart showing an exemplary processing procedure of a shop computer in the electronic commerce system of FIG. 1 with respect to an ABORT processing request from a transaction management computer.

### DETAILED DESCRIPTION OF THE INVENTION

First, the major features of embodiments of the present invention will be briefly summarized.

In embodiments of the present invention, a transaction management computer is provided on a network to which client computers and shop computers are connected. This transaction management computer records and manages information on transactions between the client computers of the users and the shop computers of the electronic shops. A processing for finalizing completion or failure of each transaction is executed under the management of the transaction management computer according to a command from a user.

As a result, even in the case where a fault occurs in the client computer, the transaction in progress can be continued by re-connecting the client computer to the transaction management computer.

Also, even in the case of a fault in the shop computer or the fault due to the network disconnection, the packet loss, etc., the commitment processing can be continued by re-transmitting messages necessary for the commitment between the transaction management computer and the shop computer using the fault recovery function provided by the transaction management computer.

As a result, both the user and the electronic shop can carry out the electronic commerce with a sense of security, because the recovery processing will be carried out by the transaction management computer even if a fault occurs.

In addition, the user can use the transaction management computer as a global shopping cart function that enables the collective commitment of transactions at a plurality of different electronic shops.

Moreover, the user can also use the transaction management computer as a centralized management function that collectively records transaction logs of the user.

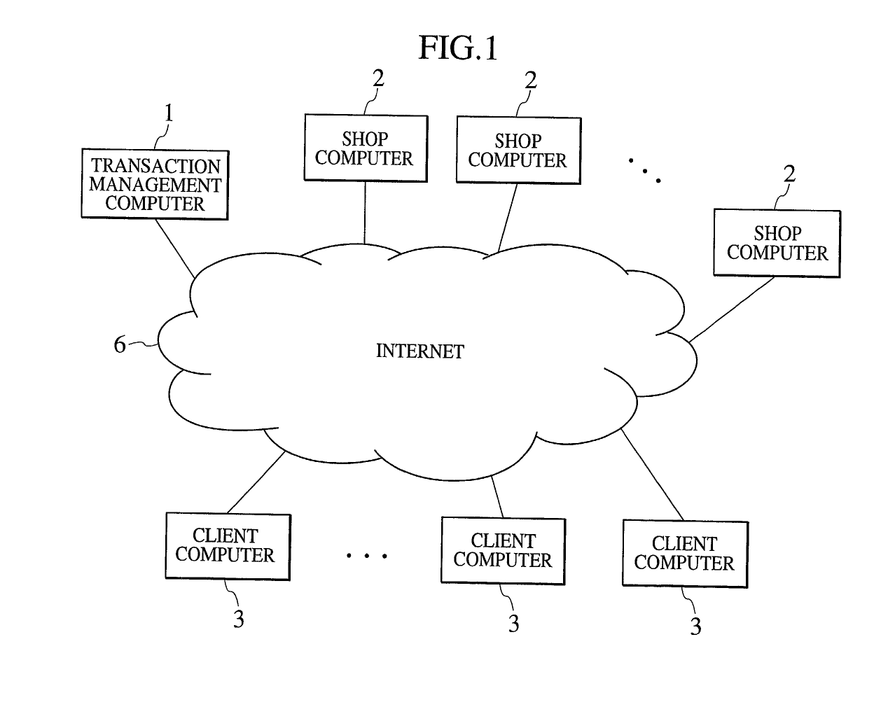

Referring now to FIG. 1 to FIG. 43, one embodiment of method and system for electronic commerce according to the present invention will be described in detail.

In the following, the exemplary case of the electronic commerce at the so called electronic shops on the Internet will be described, but the present invention is equally applicable to networks other than the Internet, and the present invention is also applicable to a system for handling transactions or contracts that are not related to the electronic commerce.

FIG. 1 shows an exemplary network configuration of an electronic commerce system according to this embodiment.

This electronic commerce system comprises a transaction management computer 1 of a transaction management service (TMS) provider, a plurality of shop computers 2 of a plurality of electronic shop service providers, and a plurality of client computers 3 of a plurality of electronic shop service users, which are interconnected through the Internet 6.

In the following, the term “user” indicates a user of a client computer 3. The user operates the client computer 3 to utilize the electronic shop service on the Internet 6 as a customer, so as to carry out desired transactions such as those for product purchases, home delivery service orders, seat or room reservations, and rental service orders (i.e., so as to make desired bilateral contracts in which the user normally has an obligation to pay fees or the like).

On the client computer 3 used by the user in order to utilize the electronic shop service, a WEB browser is operated. The user utilizes the electronic shop service (views the product information and carries out the product purchasing procedure or the like, for example) by repeating operations for accessing a desired shop computer 2 that provides a desired electronic shop service for making product purchases or the like, from the WEB browser through the Internet 6, viewing page screens displayed by the WEB browser, entering data according to needs, and pressing various buttons (through exchanges including transmission of various requests and reception of replies between both computers). It is also possible to use software different from the WEB browser such as a dedicated software for utilizing the electronic shop services, but the exemplary case of using the WEB browser will be described in this embodiment.

Also, the client computer 3 has a mechanism for carrying out communications (a communication software and a communication interface device, for example) with the transaction management computer 1 and the shop computers 2.

Note that the client computer 3 can be connected to the Internet 6 either via an Internet service provider not shown in the figures, or directly without using any Internet service provider.

On the shop computer 2, an electronic shop program is operated to provide various electronic shop services of each site, such as the sales processing including the presentation of the product or service content description and the price, the inventory checking in response to an order from the user, the payment processing, and the delivery arrangement, that is provided at a product sales service site, for example. The electronic shop program on the shop computer 2 carries out the processing while managing necessary information such as information regarding product catalogs, information regarding stocks, information regarding individual transaction content, information regarding actual payment and delivery, etc., in a database.

Also, the shop computer 2 has a mechanism for carrying out communications (a communication software and a communication interface device, for example) with the transaction management computer 1 and the client computers 3.

The transaction management computer 1 also provides a global shopping cart that can be utilized across electronic shop sites (hereafter this global shopping cart will be referred to simply as a shopping cart while an ordinary shopping cart provided at the electronic shop site will be referred to as a local shopping cart).

The user can hold the transaction currently in progress at some electronic shop, in the shopping cart by the procedure to be described below. Note that the transaction held in the shopping cart is in a state (“ACTIVE” state to be described below) where (the entire or major part of) the transaction content itself is already determined through a certain procedure with respect to the electronic shop by the user, and (input of a command for) a notification or indication of a will (intention) to finalize completion of the transaction by the user or (input of a command for) a notification or indication of a will (intention) to discard that transaction from the shopping card, i.e., to finalize failure of the transaction is awaited.

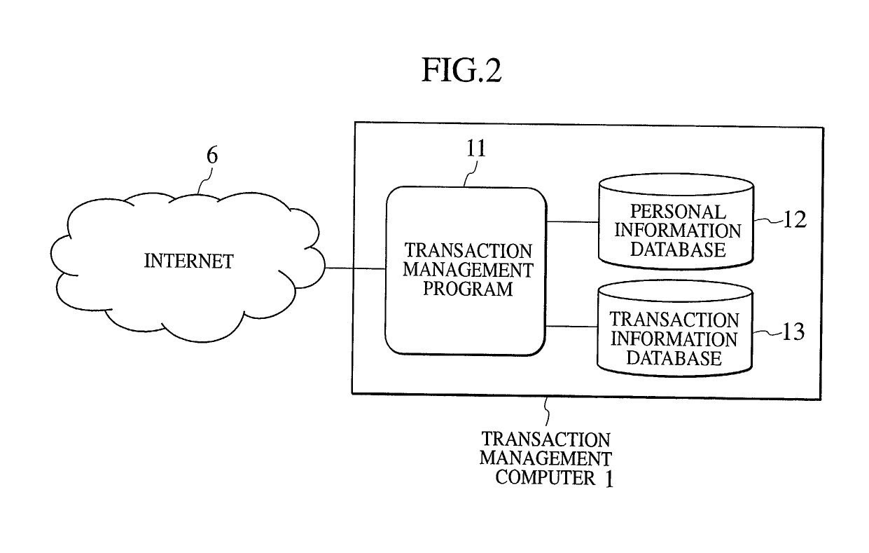

As shown in FIG. 2, on the transaction management computer 1, a transaction management program 11 for carrying out management of transactions carried out between the client computers 3 and the shop computers 2 (and for providing the shopping cart function to the user) is operated.

Also, as shown in FIG. 2, the transaction management program 11 operated on the transaction management computer 1 manages a personal information database 12 and a transaction information database 13. The personal information database 12 records the personal information of each registered user (full name, telephone number, resident address, bank account number and/or credit card number, email address, etc.) that is necessary at a time of the transaction. The transaction information database 13 records information regarding transactions currently in progress (i.e., transactions held in the shopping cart), as well as information regarding past transaction logs (transactions completed by utilizing this shopping cart) in the case of providing the transaction log service. These databases will be recording important data so that it is preferable to manage them while guaranteeing ACID (Atomicity, Concurrency, Isolation, Durability) by using a database management system such that data will not be lost by a fault.

Also, the transaction management computer 1 has a mechanism for carrying out communications (a communication software and a communication interface device, for example) with the shop computers 2 and the client computers 3.

In this embodiment, it is possible for the user to receive the electronic shop service by the shop computer 2 by utilizing (the shopping cart of) the transaction management service by the transaction management computer 1 or receive the electronic shop service without utilizing the transaction management service.

In the case of utilizing the transaction management service, the content of the transaction (between the user and the contracting entity on the electronic shop side) is determined when the user carries out the operation through the page of the electronic shop first, and completion of that transaction is held when the user presses a “button for utilizing the transaction management service” on the page of the electronic shop as displayed by the WEB browser, for example. Then, the processing for finalizing completion of that transaction (the processing for completing the procedure to validate that transaction) is started when the user presses a “button for finalizing completion of the transaction” on the page of the transaction management service as displayed by the WEB browser, for example, or the processing for finalizing failure of that transaction (the processing for cancelling or discarding the procedure related to that transaction that is made up to that point) is started when the user presses a “button for finalizing failure of the transaction”.

Also, in the case of utilizing the transaction management service, the user can hold a plurality of transactions in the shopping cart first, and then finalize completion or failure of these transactions collectively (the user can also finalize completion or failure of each transaction separately), as will be described in detail below.

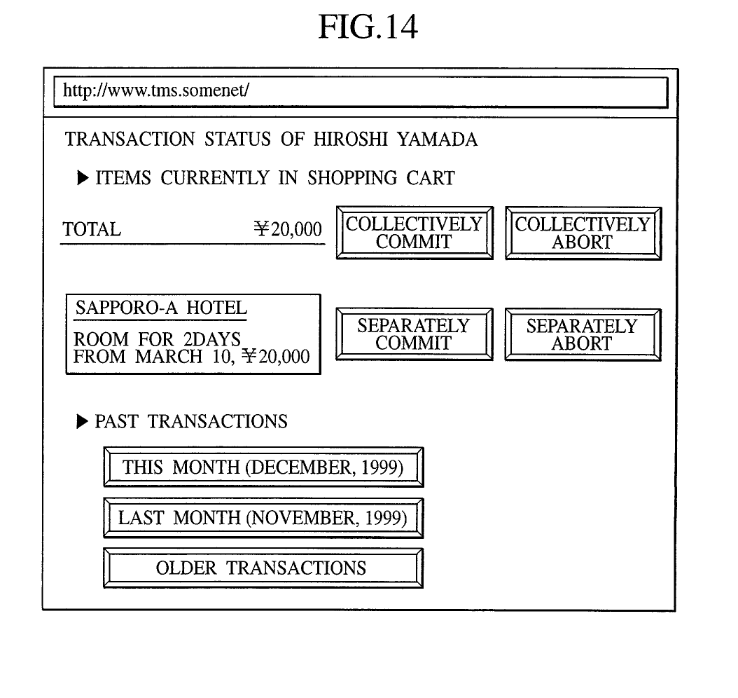

Note that, the following description is directed to an exemplary case of making the commitment using the withdrawal from a specified account as often adopted in the existing electronic shops, so that the “button for finalizing completion of the transaction” is displayed on the page screen as “commit button” (“collectively commit button” and “separately commit button”) by emphasizing the commitment aspect (see FIG. 14).

It is also possible to handle other types of transactions such as those in which the price is to be payed at a time of delivery of the product, the fee is to be payed at an airport counter on the day of actually taking the airplane, or the fee is to be payed after actually staying in a room (an appropriate processing can be carried out at each site). It is also possible to use the other names for the button such as “confirmation button”, “settlement button”, “decision button”, “subscription button”, etc. It is also possible to use a name such as the “purchase button” even when there are transactions other than the sales transactions (as long as the users are not confused). It is also possible to use GUI other than buttons. It is also possible to use the speech input instead of or in addition to the GUI.

Also, the “button for finalizing failure of the transaction” is displayed on the page screen as “abort button” (“collectively abort button” and “separately abort button”) by emphasizing the commitment aspect (see FIG. 14), but it is also possible to use the other names for the button, it is also possible to use GUI other than buttons, and it is also possible to use the speech input instead of or in addition to the GUI, similarly as described above.

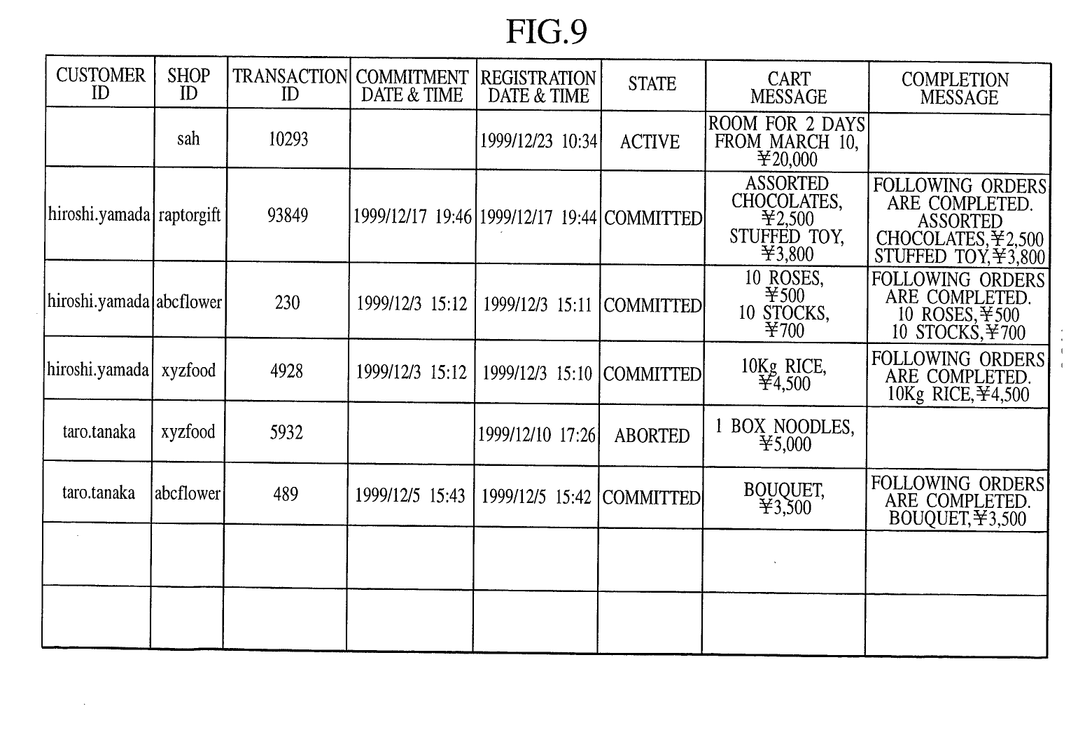

Also, in the transaction information database 13 (see FIG. 9) managed by the transaction management computer 1, a field for recording date and time at which the user has pressed the “button for finalizing completion of the transaction” for one or a plurality of transactions, i.e., the “collectively commit button” or the “separately commit button” (or date and time at which information transmitted from the client computer 3 as a result of pressing of that button is received by the transaction management computer 1) is called “commitment date and time” field in correspondence to the “collectively/separately commit button”, but the other names such as “confirmation date and time”, “settlement date and time”, “decision date and time” and “subscription date and time” can be used instead.

Also, the following description is directed to the exemplary case of reserving a room of the hotel or the like by utilizing the electronic shop, so that the “button for utilizing the transaction management service” is displayed on the page screen as “reserve by TMS button” or “pay by TMS button”, and a button to be pressed in the case of not utilizing the transaction management service is displayed on the page screen as “reserve button” or “payment button” (see FIG. 8). In the case of the product purchasing site, the name of the button such as “purchase by TMS button” can be used, for example. Also, the other names such as “button for utilizing the shopping cart of TMS”, “button for putting product into the shopping cart of TMS” can be used for the buttons, it is also possible to use GUI other than buttons, and it is also possible to use the speech input instead of or in addition to the GUI, similarly as described above.

Note that, there are various possible styles for the user of the client computer 3 to utilize the electronic shop service provided by the shop computer 2, including a style in which no membership is required so that anyone can utilize that site unconditionally, a style in which no membership is required but only those who satisfy certain condition can utilize that site, a style in which only users who paid fees for the membership of that site can utilize that site, a style in which different service contents are provided to the members and non-members of that site, etc. There are also various possible styles for charging the fee for utilization of that site, including a style in which no fee is changed to anyone, a style in which a basic registration fee is charged every month to the users who have the membership, etc.

A style for the user of the client computer 3 to utilize the transaction management service provided by the transaction management computer 1 and a style for charging the fee for utilization of that site can be similar to those described above. However, in this embodiment, it is assumed that a procedure for registering information regarding the user into the personal information database 12 of the transaction management computer 1 is to be carried out before or when the user of the client computer 3 utilizes the transaction management service of the transaction management computer 1.

A style for the electronic shop service provider of the shop computer 2 to utilize the transaction management service provided by the transaction management computer 1 is assumed to be that in which only those electronic shop service providers who made contracts with the transaction management service provider can utilize in this embodiment, but it is also possible to use a style in which any electronic shop service providers can utilize either unconditionally or under certain condition. Also, a style for charging the fee for utilization of that site can be either that in which no fee is charged or that in which some fee is charged. In the latter case, there are various possible styles for paying the fee, including a style in which the electronic shop service provider pays a certain contract fee, a style in which the electronic shop service provider pays the fee according to the contents of the transactions that are completed through the transaction management service at that site, etc.

Now, this embodiment will be described in further details for a concrete exemplary case.

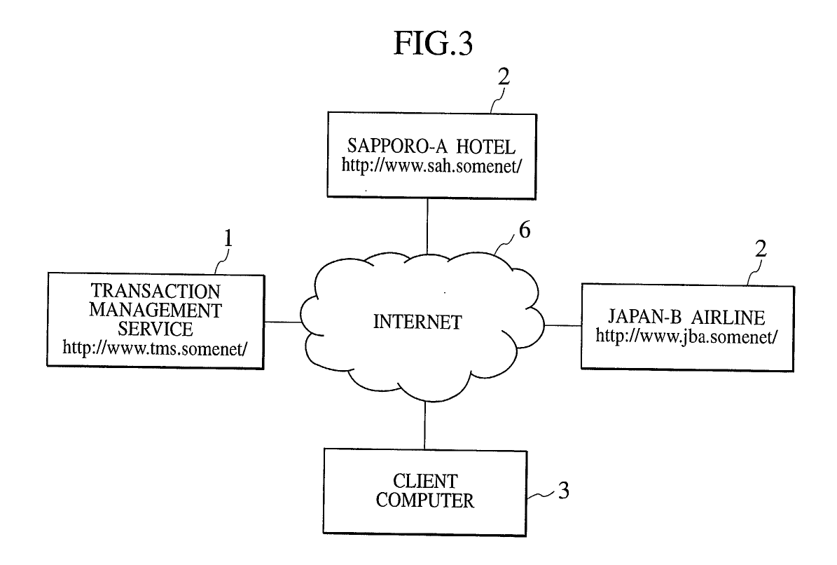

The concrete example to be described here is a case as shown in FIG. 3, in which a certain user operates the WEB browser on the own client computer 3 to utilize the electronic shop services provided on the Internet 6 by the shop computer 2 of a “Sapporo-A hotel” and the shop computer 2 of a “Japan-B airline”, in order to arrange a trip for going from Tokyo to Sapporo by airplane on March 10, staying two nights there, and coming back to Tokyo by airplane (by reserving Japan-B airline's airplane seats for going and returning between Tokyo and Sapporo and the Sapporo-A hotel's room for two nights of March 10 and March 11) by utilizing the transaction management service provided by the transaction management computer 1.

Note that, in FIG. 3, it is assumed that the transaction management computer 1 is provided at the transaction management service site and the transaction management program 11 on the transaction management computer 1 is accessible at the URL: “http://www.tms.somenet/”. It is also assumed that the shop computer 2 of the Sapporo-A hotel is accessible at the URL: “http://www.sah.somenet/”, and the shop computer 2 of the Japan-B airline is accessible at the URL: “http://www.jba.somenet/”.

Here, the user is expected to make reservations only when it is possible to make reservations for both the Sapporo-A hotel and the Japan-B airline together, and make no reservations when it is not possible to make reservations for either one or both of them.

In the following, the case where the user carries out operations for making such reservations will be described along a flow of information among the client computer 3, the shop computers 2 and the transaction management computer 1 and a flow of pages displayed on a display screen of the client computer 3.

Note that, in this embodiment, it is assumed that communications among the client computer 3, the shop computers 2 and the transaction management computer 1 are carried out by the HTTP. It is also preferable to provide higher security using SSL (Secure Socket Layer) or the like according to the need.

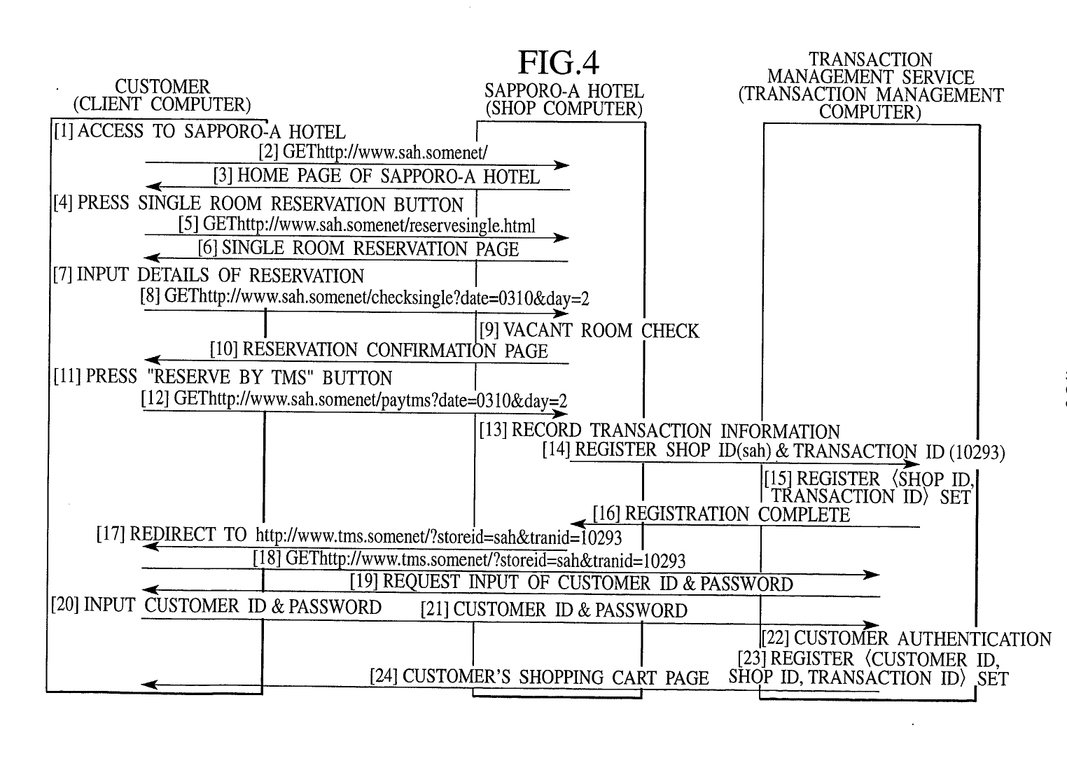

First, the user starts the procedure for making reservation at the Sapporo-A hotel by using the WEB browser of the client computer 3 (which can be the user's own computer, for example). The processing flow in this case is as shown in FIG. 4.

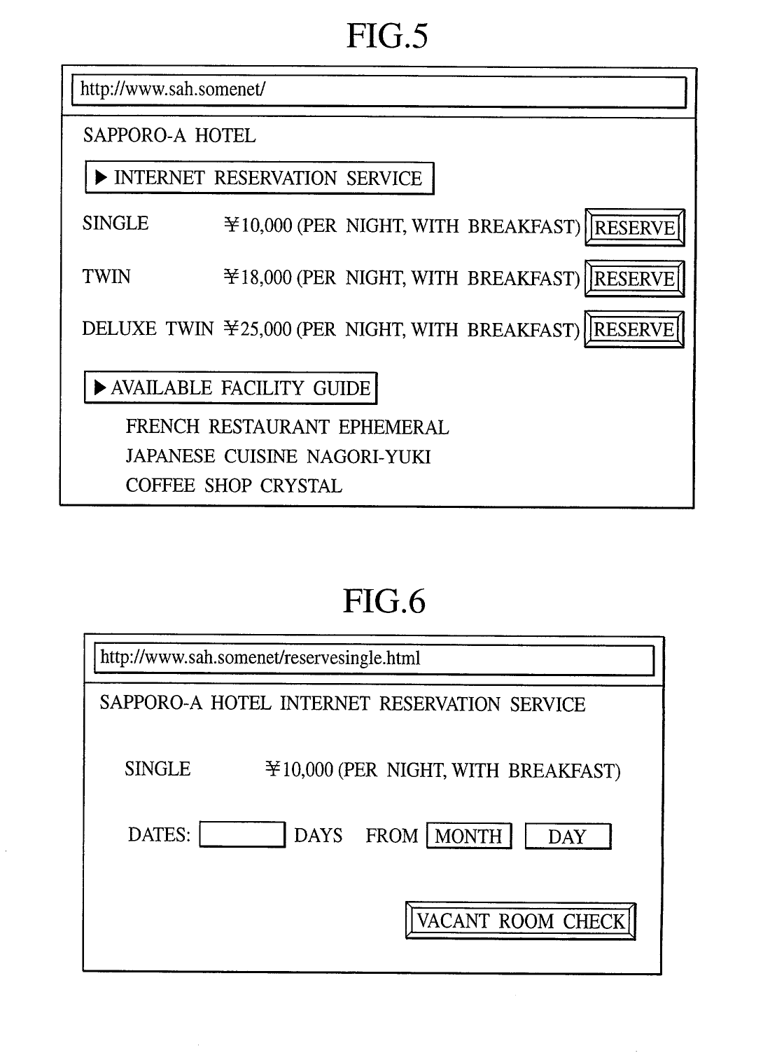

When the user enters the URL of the Sapporo-A hotel (“http://www.sah.somenet/” in this example) into the WEB browser in order to access the home page of the Sapporo-A hotel ([1] of FIG. 4), a GET request is sent to the shop computer 2 of the Sapporo-A hotel ([2] of FIG. 4), and as a result, the home page of the Sapporo-A hotel is returned from that shop computer 2 ([3] of FIG. 4) and displayed at the WEB browser on the client computer 3 as shown in FIG. 5, for example.

The user can make reservation for stays or view information on facilities in the hotel. Here, the user wishes to make a reservation for a single room, and when the user presses “Reserve” button ([4] of FIG. 4), a GET request for a single room reservation page is sent to the shop computer 2 of the Sapporo-A hotel ([5] of FIG. 4), and in response the single room reservation page is returned from that shop computer 2 ([6] of FIG. 4) and displayed at the WEB browser on the client computer 2 as shown in FIG. 6, for example.

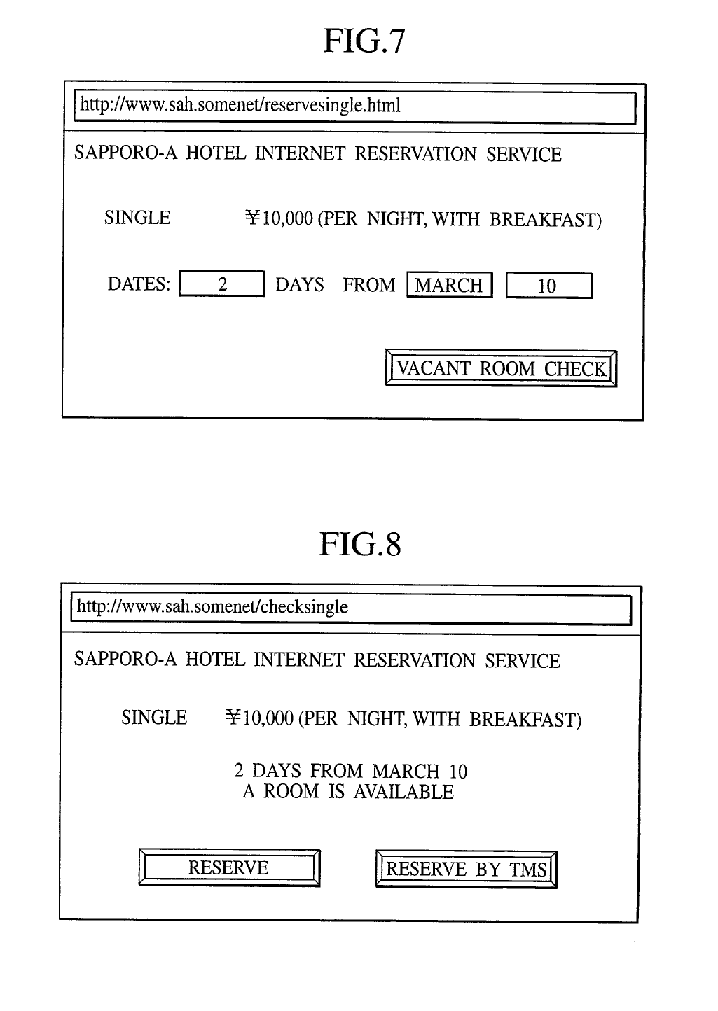

In this displayed page, the user enters the reservation content given by the desired dates (2 days from March 10 in this example) ([7] of FIG. 4) as shown in FIG. 7. When the user presses a “vacant room check” button, a GET request for the reservation confirmation is sent ([8] of FIG. 4). In this GET request, the reservation content is specified as a query of the URL: “date=0310&day=2”.

Upon receiving this GET request, the shop computer 2 of the Sapporo-A hotel checks vacant rooms ([9] of FIG. 4), and if the reservation is acceptable, a reservation confirmation page is returned ([10] of FIG. 4) and displayed at the WEB browser on the client computer 3 as shown in FIG. 8, for example.

Note that if the reservation is not acceptable because all the rooms are full as a result of checking vacant rooms, a page for displaying this fact is sent from the shop computer 2 of the Sapporo-A hotel and this fact is displayed at the WEB browser on the client computer 3.

When the user is satisfied with the content of the reservation confirmation page of FIG. 8, the reservation procedure is started. In FIG. 8, there are two buttons “Reserve” and “Reserve by TMS”. The “Reserve by TMS” button is to be pressed in the case of utilizing (the shopping cart function of) the transaction management service of the transaction management computer 1, and the “Reserve” button is to be pressed in the case of not utilizing the transaction management service.

When the “Reserve” button is pressed, the procedure for making the reservation is carried out between the client computer 3 and the shop computer 2 (where the input of the bank account number of the credit card number to be used for the payment or the like is also made according to the need), in an ordinary manner.

In this example, the user presses the “Reserve by TMS” button in order to hold this transaction in the shopping cart.

When the user presses the “Reserve by TMS” button in the reservation confirmation page of FIG. 8 ([11] of FIG. 4), a GET request for making a reservation by using the transaction management computer 1 is sent to the shop computer 2 of the Sapporo-A hotel ([12] of FIG. 4). Note here that the reservation content (“date=0310&day=2” in this example) is also sent as a query of the URL, but it is also possible to use the implementation in which the reservation content is memorized at the shop computer 2 side using a mechanism such as COOKIE.

Upon receiving this GET request for the “Reserve by TMS” button, the shop computer 2 of the Sapporo-A hotel records the reservation content (transaction content) into the database ([13] of FIG. 4). Here, a transaction ID for identifying this reservation is issued, and the reservation content and the transaction ID are recorded in correspondence. Between the shop computer 2 and the transaction management computer 1, an individual transaction is identified using this transaction ID. There is no need for the transaction management computer 1 side to know the specific transaction content (such as the reservation content described above or a product ID and the number of products to be purchased in the case of the product sales, for example).

Note that, when the GET request for the “Reserve” button is received, the reservation is finalized at that point and the processing for definitively reserving the room on the specified dates for this user will be carried out in the ordinary manner, but when the GET request for the “Reserve by TMS” button is received, the user holds a right to cancel the reservation so that the reservation is not finalized, and the processing for definitively reserving the room on the specified dates for this user will not be carried out.

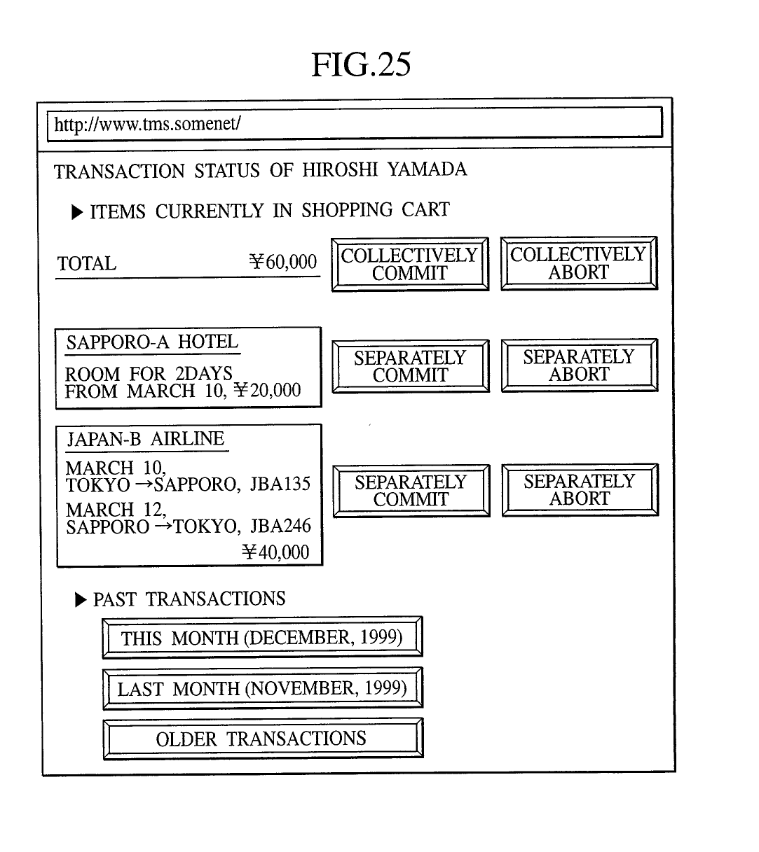

However, in this embodiment, it is assumed that each electronic shop is operated in such a way that, when the GET request for the “Reserve by TMS” button is received, the room on the specified dates for this user is tentatively reserved in order to avoid a situation where the reservation with this content becomes unavailable later on, and when this reservation is finalized later on as the user presses a “collectively commit button” (see FIG. 25), for example, the processing for updating this tentative reservation to the definitive reservation is carried out in the processing for finalizing completion of the transaction (or releasing the tentative reservation in the case of finalizing failure of the transaction).

Now, the shop computer 2 also registers a set of the transaction ID and the own shop ID that is registered at the transaction management computer 1 into the transaction management computer 1 ([14] of FIG. 4). Here, the shop ID of the Sapporo-A hotel is assumed to be “sah”, and the transaction ID of this reservation is “10293”.

The transaction information database 13 managed by the transaction management computer 1 is implemented in a form of a table shown in FIG. 9, for example, where each row of the table records a single transaction information. In the example of FIG. 9, each row is formed by eight fields including the following.

A “customer ID” is a field for storing an identifier of the user related to that transaction.

A “shop ID” is a field for storing an identifier of the electronic shop related to that transaction. Note that one shop computer 2 may have a plurality of different electronic shops.

A “transaction ID” is a field for storing information for identifying each transaction.

A “commitment date and time” is a field for recording date and time at which the user pressed a “collectively commit” button or a “separately commit” button (see FIG. 25) (or date and time at which a message sent from the client computer 3 in response to the pressing of that button is received). Note that this “commitment date and time” field will also be used for recording a time at which the state of the transaction was changed last or a time at which a message was re-transmitted in the case of the fault, until the state of the corresponding transaction becomes “COMMITTED”, as will be described below. It is also possible to provide another field for recording such a time of the state change until the state of the corresponding transaction becomes “COMMITTED”.

A “registration date and time” is a field for recording date and time at which that transaction is registered at the transaction management computer 1.

A “state” is a field for indicating a state of that transaction. In the example of FIG. 9, “COMMITTED” indicates a state in which the transaction is completed, “ABORTED” indicates a state in which the transaction is once put into the shopping cart and then cancelled later on, and “ACTIVE” indicates a state in which the transaction is currently in progress and its completion is not finalized (a state in which the transaction is held in the shopping cart).

A “cart message” is a field for recording information regarding the content of that transaction, which is utilized at a time of displaying information on that transaction in the user's personal shopping cart page.

A “completion message” is a field for recording a message to the user from the electronic shop when the processing for finalizing the transaction is completed. Consequently, the transaction in the state of “ABORTED” will not have any completion message.

FIG. 9 shows a state of the transaction information database 13 immediately after the transaction management computer 1 has received the transaction information with the shop ID “sah” and the transaction ID “10293” from the shop computer 2 of the Sapporo-A hotel and registered that transaction information ([15] of FIG. 4). The first row of FIG. 9 corresponds to this transaction, where the correspondence with the customer ID is not established yet and the transaction is not completed yet, so that the customer ID and the commitment date and time are blank and the state is “ACTIVE”. The content of the cart message is assumed to be sent along with a message for registering the shop ID and the transaction ID.

Note that it is also possible to use a configuration in which the shop computer 2 is enabled to acquire the customer ID by transmitting the customer ID or information that can specify the customer ID from the client computer 3 to the shop computer 2, and the customer ID is also transmitted along with the shop ID and the transaction ID from the shop computer 2 to the transaction management computer 1 such that the customer ID is also registered into the transaction information database 13 at this point.

When the registration into the transaction information database 13 is finished in this way, the transaction management computer 1 notifies the registration completion to the shop computer 2 ([16] of FIG. 4).

Upon receiving the registration completion notice from the transaction management computer 1, the shop computer 2 commands REDIRECT of the HTTP to access the transaction management computer 1 using the shop ID (sah) and the transaction ID (10293), with respect to the client computer 3 ([17] of FIG. 4). In this embodiment, the shop computer 2 commands REDIRECT by specifying the URL of the transaction management computer 1 which has the shop ID and the transaction ID as a query, with respect to the client computer 3.

Upon receiving the REDIRECT command, the client computer 3 sends a GET request to the specified URL of the transaction management computer 1 (which is “http://www.tms.somenet/” in this example) ([18] of FIG. 4).

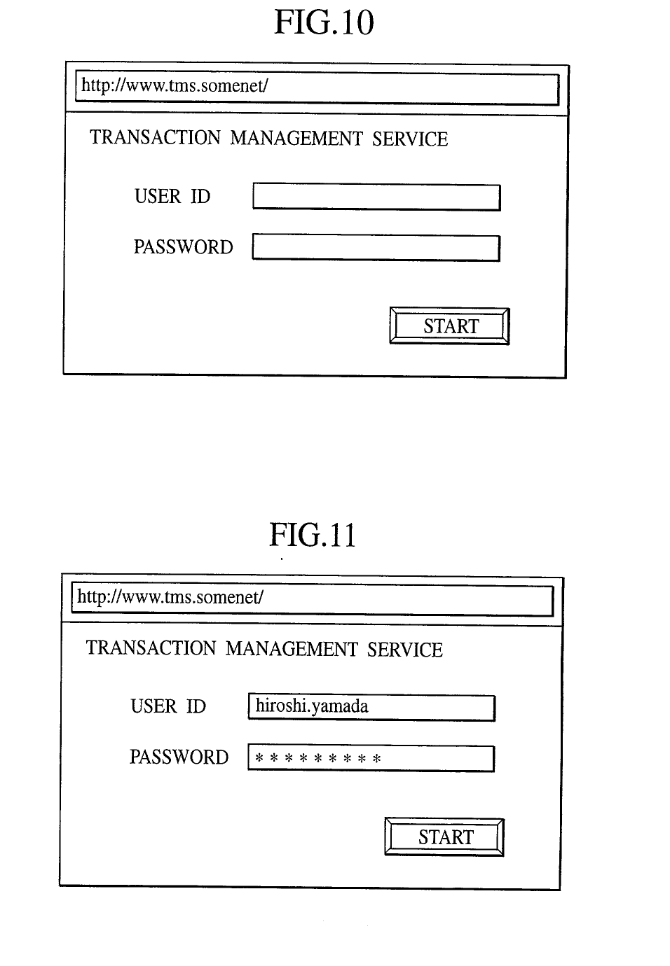

Upon receiving this GET request from the client computer 3, the transaction management computer 1 first urges input of the customer ID and a password in order to carry out the user authentication ([19] of FIG. 4). At this point, the display at the client computer 3 appears as shown in FIG. 10, for example. When the user enters the customer ID and the password using this display ([20] of FIG. 4) as shown in FIG. 11, this information is sent to the transaction management computer 1 ([21] of FIG. 4), and the transaction management computer 1 carries out the user authentication by referring to the personal information database 12 ([22] of FIG. 4).

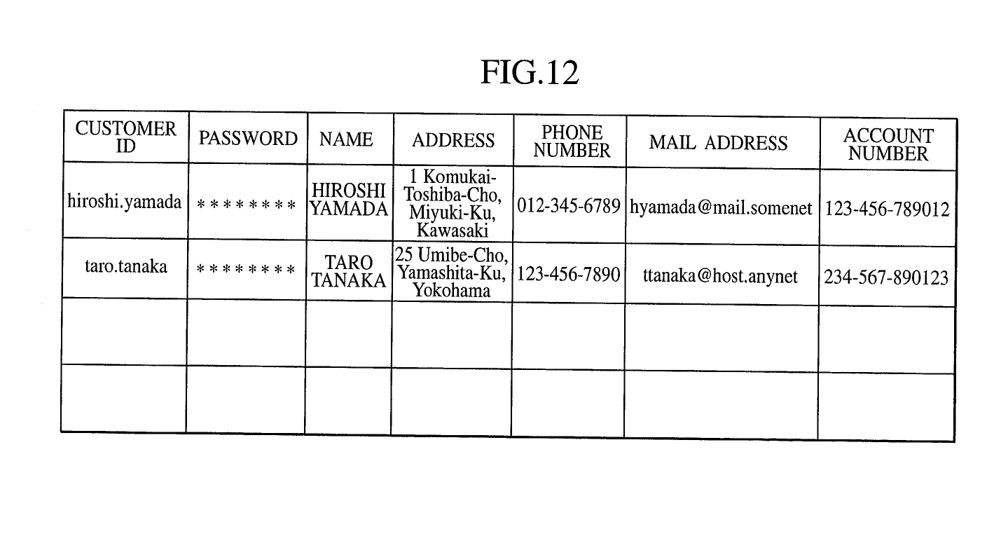

The personal information database 12 managed by the transaction management computer 1 can be implemented as a table in a structure as shown in FIG. 12, for example. Each row of the table records a single personal information, and in the example of FIG. 12, each row is formed by seven fields including the following.

A “customer ID” field records a unique identification name assigned to that user.

A “password” field records the password to be used in authenticating that user.

A “name” field records a full name of the user.

An “address” field records a resident address of the user, etc.

A “phone number” field records a telephone number of the user, etc.

A “mail address” field records an e-mail address of the user.

An “account number” field records a bank account number to be used for the payment of the charge or the like.

The personal information database 12 may also records various other information. Depending on the payment method to be used, it is also possible to provide a field for recording the credit card number, for example. On the contrary, it is also possible to provide no field for the account number of the credit card number so that no information regarding the payment method is recorded.

Here, the authentication is carried out by searching through the personal information database 12 by using the customer ID out of the customer ID and the password sent from the user, and comparing the password recorded in the personal information database 12 with the password sent from the user.

Note that there are various authentication schemes other than that described above, and any authentication scheme may be used here. Depending on the authentication scheme, there can be cases where the password is not directly recorded in the personal information database 12, and there can be cases where the other necessary information is to be recorded in the personal information database 12.

Note also that this embodiment is directed to the exemplary case where no subsequent user authentication is necessary while the WEB browser of the client computer 3 of the user remains activated, and the user authentication is newly required when the WEB browser is re-activated as the client computer 3 is disabled once and then re-activated.

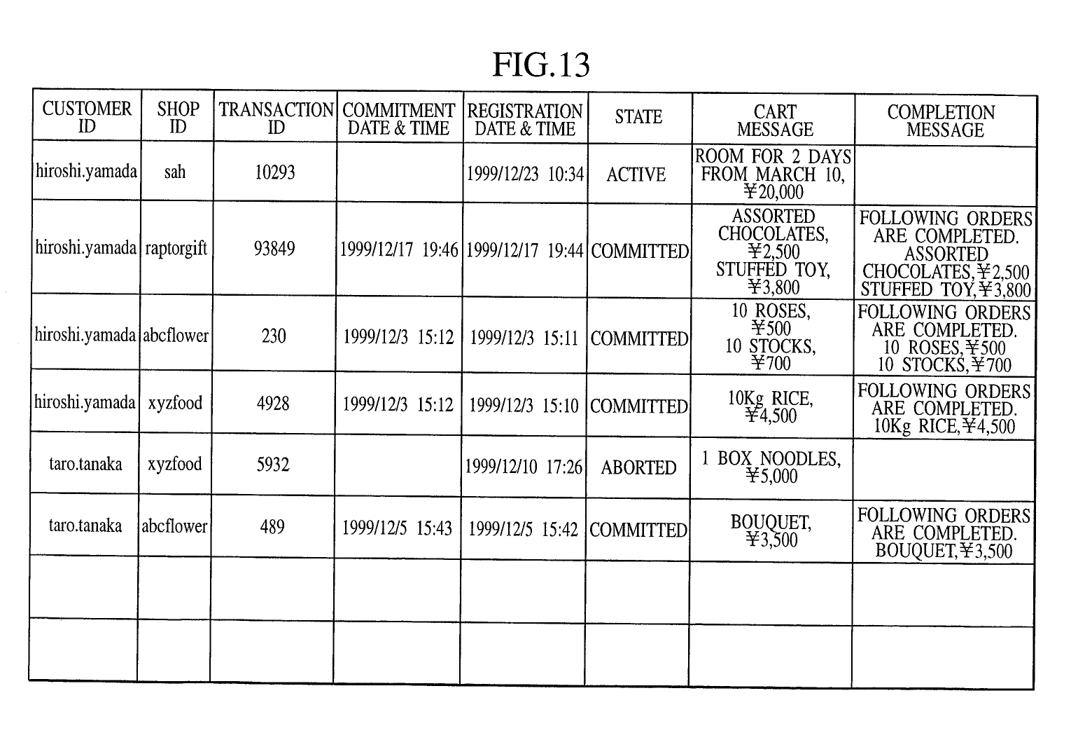

Now, at the transaction management computer 1, the customer ID of the user who made access can be ascertained when the user authentication is finished. In the case of this example, the customer ID is “hiroshi.yamada”. The corresponding transaction information is retrieved from the transaction information database 13 by using the shop ID and the transaction ID associated with the request, and as the customer ID field of that transaction information is blank, the customer ID of the user who made access is recorded there ([23] of FIG. 4). As a result, the transaction information database 13 is put in a state shown in FIG. 13, which differs from that of FIG. 9 in that the customer ID field is now filled.

When the registration into the transaction information database 13 is completed, the transaction management computer 1 takes out the transaction information having the customer ID of the user who made access, from the transaction information database 13, creates a shopping cart page for displaying that information, and returns the shopping cart page to the client computer 3 ([24] of FIG. 4).

When this shopping cart page is displayed at the WEB browser on the client computer 3, it appears as shown in FIG. 14, for example. In FIG. 14, information on the transaction which is in the “ACTIVE” state (that is, the transaction which is currently in progress and its completion is not finalized yet) is displayed as “Items currently in shopping cart”. Here, the transaction information for the transaction at the electronic shop of the Sapporo-A hotel that is just made is in the shopping cart, and there are buttons for committing or aborting this transaction. For the display of the individual transaction information in this shopping cart screen, the value of the “cart message” field in the transaction information database 13 of the transaction management computer 1 is used. In this display screen, by pressing a “this month (December, 1999)” button or the like that is provided at a lower part of the display screen, it is also possible to open a display screen for displaying the corresponding information on the past transactions.

Note that, in the above description, the transaction ID is issued by the shop computer 2, but the transaction ID may be issued by the transaction management computer 1 instead. In this case, when the shop ID is notified from the shop computer 2 to the transaction management computer 1, the transaction management computer 1 registers a set of the received shop ID and a newly issued transaction ID into the transaction information database 13, and returns the issued transaction ID to the shop computer 2. Upon receiving the transaction ID, the shop computer 2 records that transaction ID and the transaction content information in correspondence into the database.

Now, when the reservation of a room of the Sapporo-A hotel is the sole purpose, it suffices to press the “(collectively or separately) commit” button in the display screen of FIG. 14, but in this example, the prescribed procedure for the reservation of seats of airplanes is to be carried out, and if it is possible to make all the desired reservations as a result, then the transactions for all the reservations are to be collectively completed by utilizing the shopping cart function (by pressing a “collectively commit” button in this example). On the other hand, if the reservation of seats of airplanes is not possible, then no transaction for any reservation is to be completed (by pressing a “separately abort” button or a “collectively abort” button with respect to the transaction with the Sapporo-A hotel that is put in the shopping cart in this example).

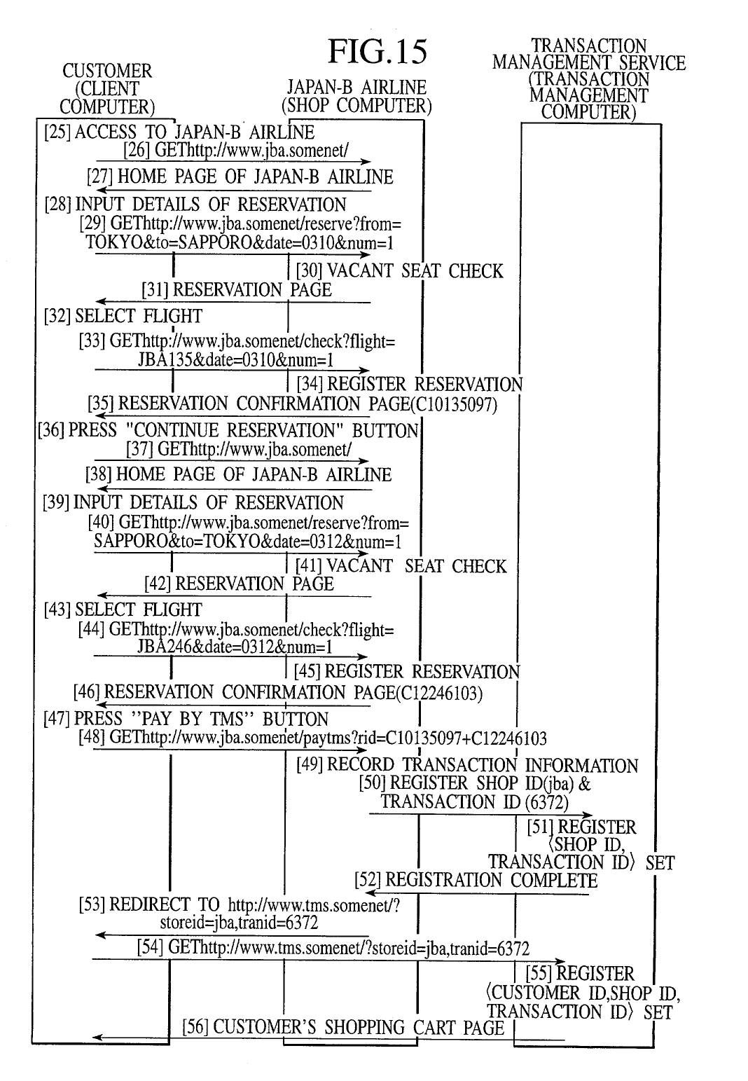

Thus the user next proceeds to the procedure for making reservation of seats of airplanes at the Internet reservation page of the Japan-B airline by using the WEB browser of the client computer 3 (which can be the user's own computer, for example). The processing flow in this case is as shown in FIG. 15.

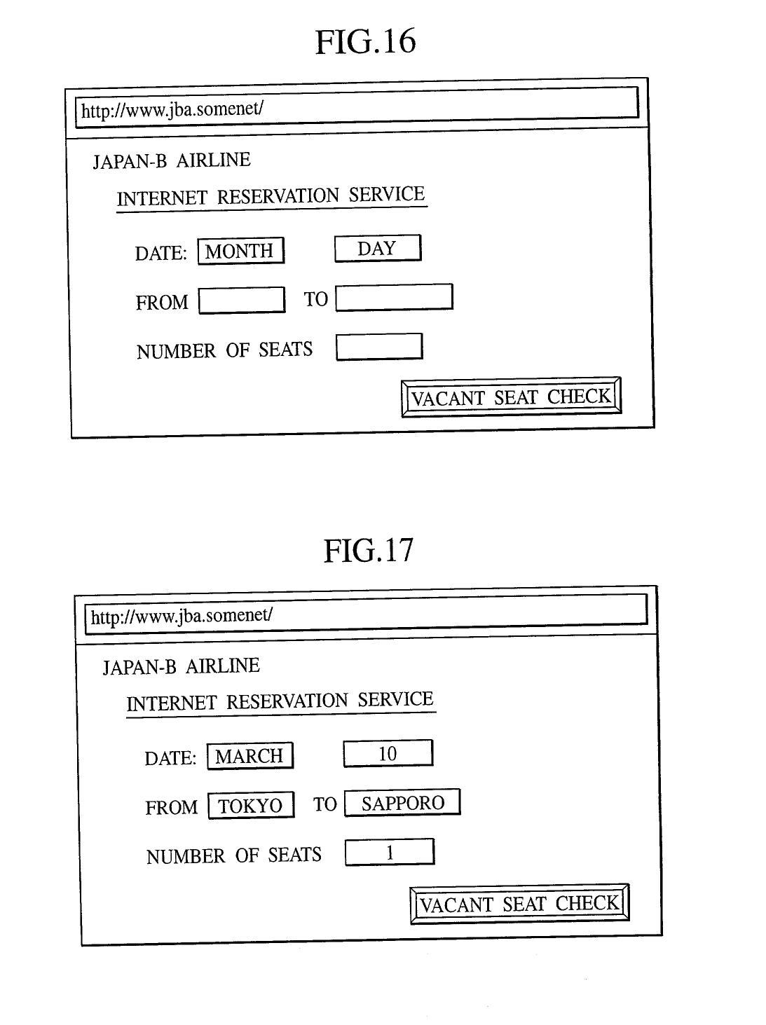

When the user enters the URL of the Japan-B airline (“http://www.jba.somenet/” in this example) into the WEB browser in order to access the home page of the Japan-B airline ([25] of FIG. 15), a GET request is sent to the shop computer 2 of the Japan-B airline ([26] of FIG. 15), and as a result, the home page of the Japan-B airline is returned from that shop computer 2 ([27] of FIG. 15) and displayed at the WEB browser on the client computer 3 as shown in FIG. 16, for example (it is assumed that the home page is the reservation page in this example).

In this reservation page of FIG. 16, the user enters the desired date, origin and destination, and number of seats (March 10, from Tokyo to Sapporo, and one seat in this example) ([28] of FIG. 15) as shown in FIG. 17. When the user presses a “vacant seat check” button after completing the input, a GET request for the vacant seat check is sent to the shop computer 2 of the Japan-B airline ([29] of FIG. 15). In this GET request, information on the desired date, origin and destination, and number of seats is specified as a query of the URL.

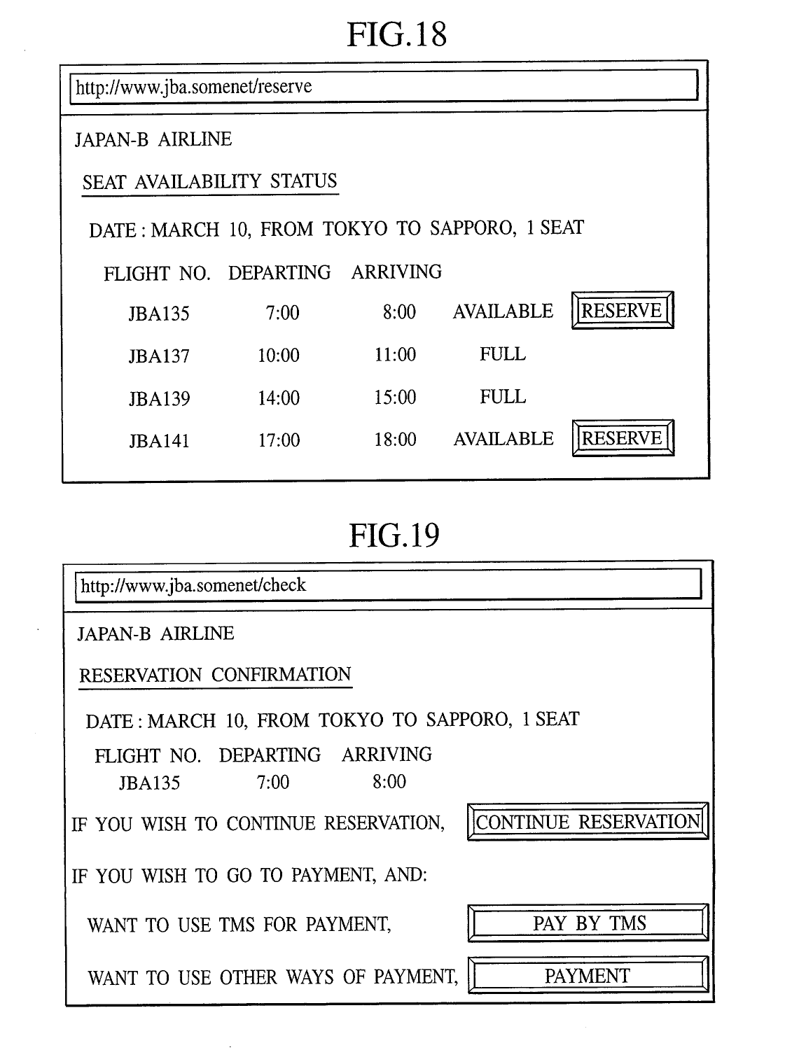

Upon receiving this GET request, the shop computer 2 of the Japan-B airline checks vacant seats that meet the request ([30] of FIG. 15), creates a page for making reservation and returns that page to the client computer 3 ([31] of FIG. 15). This page is displayed at the WEB browser on the client computer 3 as shown in FIG. 18, for example.

Note that if the reservation is not acceptable because all the seats are full as a result of checking vacant seats, a page for displaying this fact is sent from the shop computer 2 of the Japan-B airline and this fact is displayed at the WEB browser on the client computer 3, similarly as in the case of the Sapporo-A hotel.

Upon viewing the seat availability status on the display screen of FIG. 18, the user can see that there are vacant seats in flight numbers JBA135 and JBA141, and the user selects JBA135 here. When the user presses a “reserve” button for JBA135 ([32] of FIG. 15), a GET request for making a reservation of JBA135 is sent to the shop computer 2 of the Japan-B airline ([33] of FIG. 15). Note here that information on the flight number to be reserved, the desired date, origin and destination, and number of seats is also sent as a query of the URL, but it is also possible to use the implementation in which information on the desired date, origin and destination, and number of seats that was sent earlier at a time of the vacant seat check is memorized at the shop computer 2 side.

Upon receiving this GET request, the shop computer 2 of the Japan-B airline records the reservation content and a reservation number (C10135097) into the database ([34] of FIG. 15), and returns the reservation confirmation page to the client computer 3 ([35] of FIG. 15). At this point, in this embodiment, the reservation number is also returned together by using COOKIE and the WEB browser memorizes the reservation number. This reservation confirmation page is displayed at the WEB browser on the client computer 3 as shown in FIG. 19, for example.

Note that, in this embodiment, it is assumed that each electronic shop is operated in such a way that, when the GET request for the “Reserve” button is received, the seat on the specified date for this user is tentatively reserved in order to avoid a situation where the reservation with this content becomes unavailable later on, and when this reservation is finalized later on, the processing for updating this tentative reservation to the definitive reservation is carried out (or releasing the tentative reservation in the case of finalizing failure of the transaction), similarly as in the case of the Sapporo-A hotel.

Now, upon viewing the displayed page of FIG. 19, it can be seen that the user at this point has a choice of continuing the reservation of the other flight by pressing a “Continue reservation” button, carrying out the payment procedure utilizing the transaction management service provided by the transaction management computer 1 by pressing a “Pay by TMS” button, or carrying out the usual payment procedure without utilizing the transaction management service by pressing a “Payment” button.

In this example, the user is going to continue the reservation of the flight for returning by pressing the “Continue reservation” button.

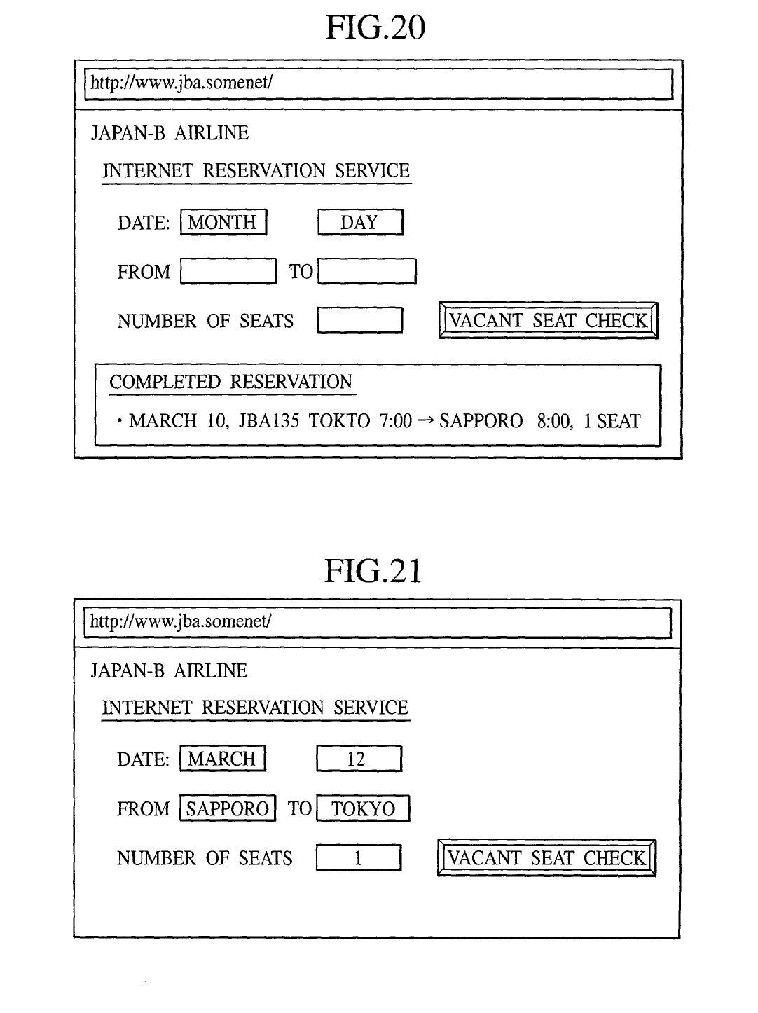

When the user presses the “Continue reservation” button in the display screen of FIG. 19 ([36] of FIG. 15), a GET request for the reservation page is sent to the shop computer 2 of the Japan-B airline ([37] of FIG. 15). Then, the reservation page is returned in response to this request ([38] of FIG. 15) and displayed at the WEB browser on the client computer 3 as shown in FIG. 16, for example. Here, it is also possible to present the information in the local shopping cart of this site as shown in FIG. 20.

In this reservation page of FIG. 16 (or FIG. 20), the user enters the desired date, origin and destination, and number of seats (March 12, from Sapporo to Tokyo, and one seat in this example) ([39] of FIG. 15) as shown in FIG. 21. When the user presses a “vacant seat check” button after completing the input, a GET request for the vacant seat check is sent to the shop computer 2 of the Japan-B airline ([40] of FIG. 15). Upon receiving this GET request, the shop computer 2 of the Japan-B airline checks vacant seats that meet the request ([41] of FIG. 15), creates a page for making reservation and returns that page to the client computer 3 ([42] of FIG. 15). This page is displayed at the WEB browser on the client computer 3 as shown in FIG. 22, for example.

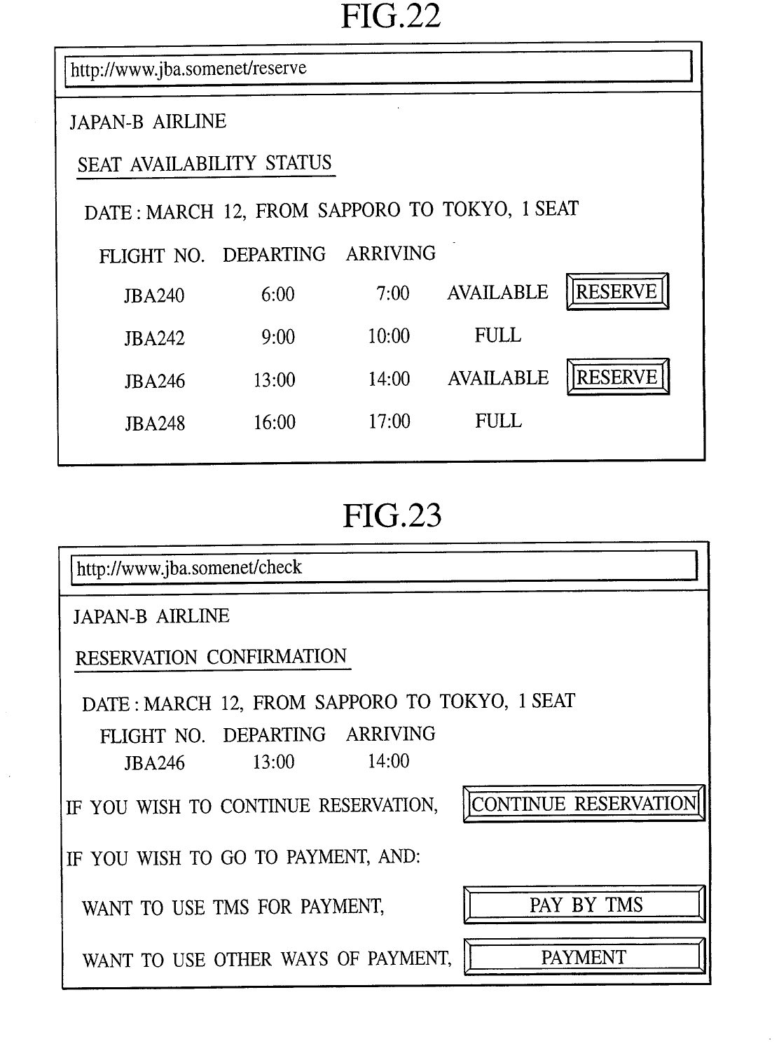

Upon viewing the seat availability status on the display screen of FIG. 22, the user can see that there are vacant seats in flight numbers JBA240 and JBA246, and the user selects JBA246 here. When the user presses a “reserve” button for JBA246 ([43] of FIG. 15), a GET request for making a reservation of JBA246 is sent to the shop computer 2 of the Japan-B airline ([44] of FIG. 15). Upon receiving this GET request, the shop computer 2 of the Japan-B airline records the reservation content and a reservation number (C12246103) into the database ([45] of FIG. 15), and returns the reservation confirmation page to the client computer 3 ([46] of FIG. 15). At this point, again, the reservation number is also returned together by using COOKIE and the WEB browser memorizes the reservation number. This reservation confirmation page is displayed at the WEB browser on the client computer 3 as shown in FIG. 23, for example.

By the operations up to this point, it becomes possible to make reservations for the airplanes for going and returning between Tokyo and Sapporo, so that the user presses the “Pay by TMS” button ([47] of FIG. 15) in order to register the transaction currently in progress (a single transaction that collectively includes the local shopping cart from a viewpoint of the transaction management computer 1) into the transaction management computer 1 (i.e., to put it in the shopping cart). When the “Pay by TMS” button is pressed, a GET request having a query indicating the reservation numbers (C10135097 and C12246103) as memorized by using COOKIE is sent to the shop computer 2 of the Japan-B airline ([48] of FIG. 15).

Upon receiving this GET request for the “Pay by TMS” button, the shop computer 2 of the Japan-B airline issues a transaction ID (6372), records the reservation content (transaction content) and the transaction ID in correspondence into the database ([49] of FIG. 15), and sends a request for registering a set of the shop ID “jba” of the electronic shop of the Japan-B airline and the transaction ID “6372” with respect to the transaction management computer 1 ([50] of FIG. 15). In this request, the cart message corresponding to this transaction ID is also attached.

The transaction management computer 1 registers the transaction information given by the received shop ID and transaction ID into the transaction information database 13 ([51] of FIG. 15), and also registers the received cart message at the same time.

When the registration into the transaction information database 13 is finished in this way, the transaction management computer 1 notifies the registration completion to the shop computer 2 ([52] of FIG. 15).

Upon receiving the registration completion notice from the transaction management computer 1, the shop computer 2 commands REDIRECT of the HTTP to access the transaction management computer 1 using the shop ID (jba) and the transaction ID (6372), with respect to the client computer 3 ([53] of FIG. 15).

Upon receiving the REDIRECT command, the client computer 3 sends a GET request to the specified URL (which is the URL of the transaction management computer 1) ([54] of FIG. 15).

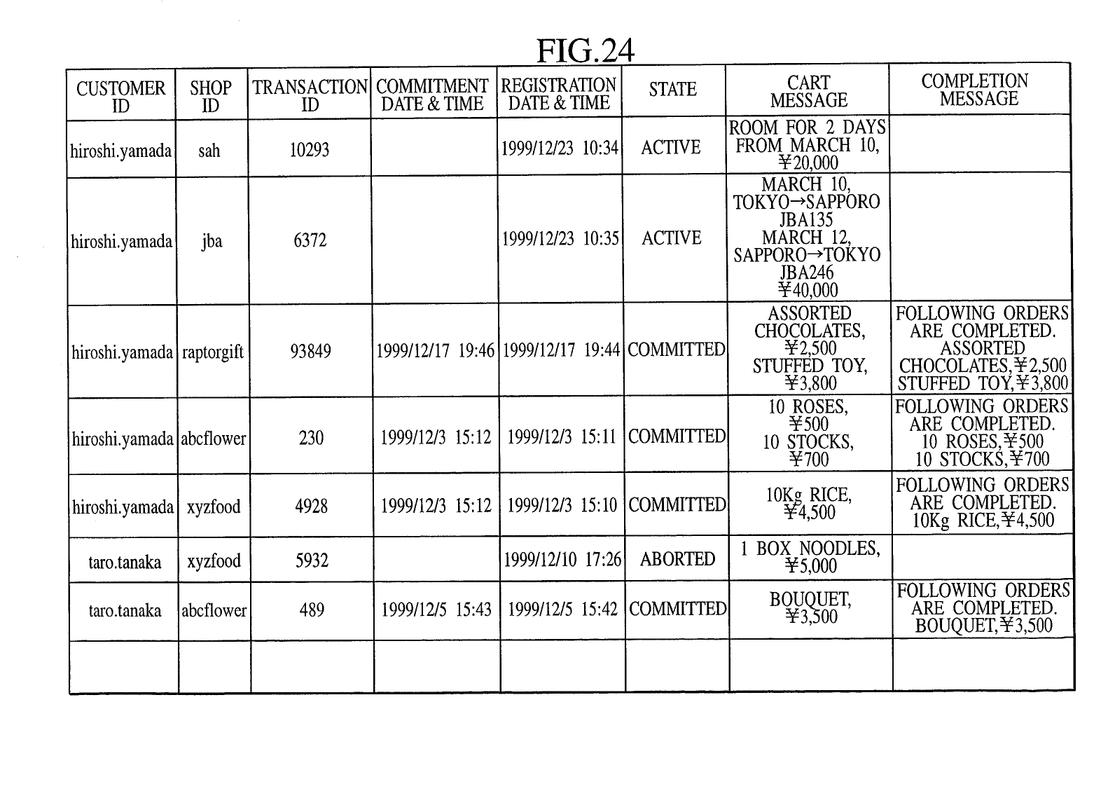

Upon receiving this GET request from the client computer 3, the user authentication is already done before in this case, so that the transaction management computer 1 retrieves the corresponding transaction information from the transaction information database 13 by using the shop ID and the transaction ID associated with the request, and as the customer ID field of that transaction information is blank, the customer ID of the user who made access is recorded there ([55] of FIG. 15). At this point, the transaction information database 13 is put in a state shown in FIG. 24.

When the registration into the transaction information database 13 is completed, the transaction management computer 1 takes out the transaction information having the customer ID of the user who made access, from the transaction information database 13, creates a shopping cart page for displaying that information, and returns the shopping cart page to the client computer 3 ([56] of FIG. 15).

When this shopping cart page is displayed at the WEB browser on the client computer 3, it appears as shown in FIG. 25, for example. In FIG. 25, it can be seen that the transaction information for the transaction at the electronic shop of the Sapporo-A hotel that was made earlier and the transaction information for the transaction at the Japan-B airline that is just made now are in the shopping cart.

Here, the electronic shop program of the shop computer 2 of the Japan-B airline has a function for processing reservations for a plurality of flights collectively by using the local shopping cart in this electronic shop. Even in such a case where the individual electronic shop or the mall has its own local shopping cart function, the transaction management computer 1 can be operated as a shopping cart for collectively handling a plurality of such local shopping carts.

Now, by the procedure up to this point, it becomes possible to reserve a room of the Sapporo-A hotel for two nights and airplane seats of the Japan-B airline for going and returning as desired, so that the user next carries out the procedure for finalizing completion of these transactions collectively by utilizing the shopping cart function. In the page of FIG. 25, two buttons labelled “Separately commit” and “Separately abort” are provided next to each of the transaction information for the Sapporo-A hotel and the transaction information for the Japan-B airline that are contained in the shopping cart. These are buttons for finalizing completion or failure of each transaction separately, with respect to the transactions currently in progress that are contained in the shopping cart. Above these buttons, two buttons labelled “Collectively commit” and “Collectively abort” are also provided. These are buttons for finalizing completion or failure of all transactions collectively, with respect to the transactions currently in progress that are contained in the shopping cart.

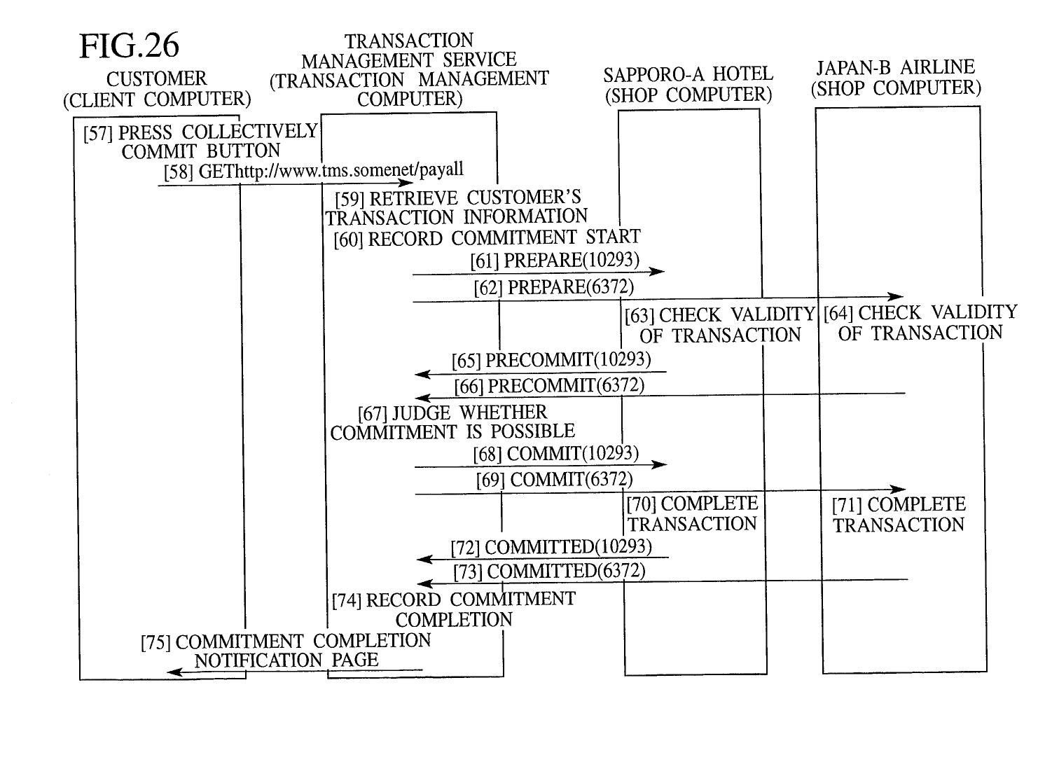

Here, the processing in the case of handling the transactions for both the Sapporo-A hotel and the Japan-B airline collectively by pressing the “Collectively commit” button will be described. The processing flow in this case is as shown in FIG. 26.

First, when the user presses the “Collectively commit” button on the shopping cart display screen of FIG. 25 ([57] of FIG. 26), a GET request for commanding the collective processing is sent from the client computer 3 to the transaction management computer 1 ([58] of FIG. 26). Upon receiving this request, the transaction management computer 1 carries out the user authentication processing if the user has not been authenticated yet. In this example, the user authentication is already done ([19],[20], [21], [22] of FIG. 4) so that this processing is omitted here.

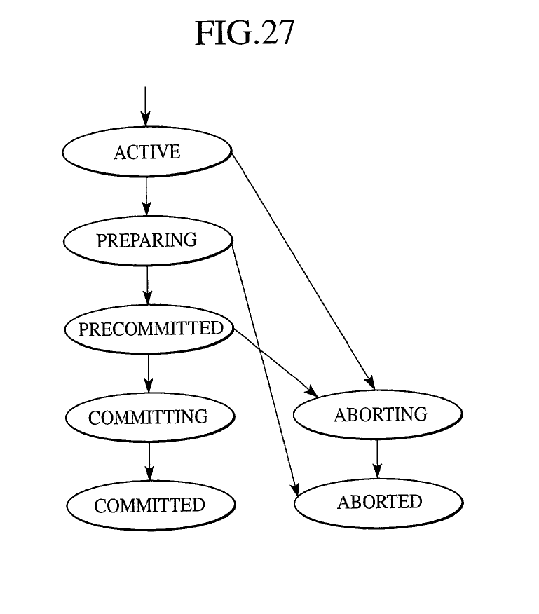

Next, the transaction management computer 1 retrieves the transaction information of the user for which the value of the state field is “ACTIVE” from the transaction information database 13 as the collective processing target ([59] of FIG. 26), and carries out the processing for finalizing these transactions according to the state transition shown in FIG. 27, interactively with the shop computer 2.

The state transition of FIG. 27 represents a transition of states recorded in the state field of each transaction information in the transaction information database 13. The basic principle is the same as the two-phase commit protocol of the distributed transaction that is widely in use.

The transaction information newly registered from the shop computer 2 is first entered into the transaction information database 13 in the “ACTIVE” state. Normally, when the collective processing is commanded by the user (by pressing the “Collectively commit” button, for example), the state of all the transactions in the “ACTIVE” state that are collective processing target is changed to “PREPARING”, and a PREPARE message for inquiring “whether the procedure to validate this transaction can be completed or not” is sent to each one of the shop computers 2 involved in the collective processing target transactions.

Note that “whether the procedure to validate this transaction can be completed or not” implies whether or not there is any factor that blocks the finalization of completion of the transaction such as: (1) if the necessary processing cannot be carried out as a trouble occurs on the system other than the communication function of the shop computer 2, or this is not the case and the system is normal, (2) if the transaction cannot be completed because of an occurrence of some event outside the system, or this is not the case and the transaction can be completed, (3) whether or not the commitment is possible, in the case where the electronic shop checks whether the commitment by the withdrawal from the specified account is actually possible or not according to the bank account number or the credit card number of the user and refuses the completion of the transaction when the commitment is not possible, and (4) whether the completion of the transaction is currently still possible or not even though the completion of the transaction was possible at a time of putting it into the shopping cart, in the case of the system in which each electronic shop is not guaranteed to tentatively reserve the product stock or the room related to the transaction in the shopping cart. When there is no such blocking factors and the completion of the transaction is possible, it is judged that the procedure to validate that transaction can be completed.

The shop computer 2 returns the PRECOMMIT message if the procedure for that transaction can be completed, so that the state of that transaction is changed to “PRECOMMITED”.

Then, when the PRECOMMIT message messages for all the transactions that are the collective processing target (two transactions in this example) are returned, the state of each transaction is changed to “COMMITTING”, and a COMMIT message is sent to each corresponding shop computer 2 to command the completion of the procedure for the corresponding transaction (that is, the execution of the processing for finalizing completion of the corresponding transaction). The shop computer 2 returns a COMMITTED message when the processing necessary for finalizing completion of the corresponding transaction is finished at that site, so that the state of that transaction is changed to “COMMITTED”. When the state of all the transactions that are the collective processing target is changed to “COMMITTED”, the collective processing is completed.

Here, upon receiving the PREPARE message, if the completion of the procedure for the transaction is not possible, the shop computer 2 carries out the processing for aborting that transaction and returns an ABORTED message, so that the state of that transaction is changed to “ABORTED”. At this point, if there is any other transaction that is the collective processing target and that is in the “PRECOMMITTED” state, the state of that transaction is changed to “ABORTING” and an ABORT message is sent to the corresponding shop computer 2 to command the execution of the processing for aborting that transaction. When the aborting (discarding) of that transaction is completed, the shop computer 2 returns the ABORTED message so that the state of that transaction is changed to “ABORTED”. When the state of all the transactions that are the collective processing target is changed to “ABORTED”, the collective processing is completed.

Note that, in the case where the separate processing is commanded from the user (by pressing the “Separately commit” button, for example), the two-phase commit processing similar to the case of the collective processing may be carried out, but it is also possible to carry out the one-phase commit processing to be described below, In the case where the user himself/herself voluntarily aborts the transaction (by pressing the “Collectively abort” button or the “Separately abort” button in the shopping cart page, for example) or in the case where the transaction management computer 1 adopts a configuration for judging whether or not the transaction is to be aborted according to prescribed criteria automatically and judges that the transaction is to be aborted, the state of the transaction to be aborted is changed from “ACTIVE” to “ABORTING”, and the ABORT message is sent to the shop computer 2. When the ABORTED message is returned from the shop computer 2 which completed the aborting of the corresponding transaction, the state of that transaction is changed to “ABORTED”. In the case of the collective aborting, when the state of all the transactions that are the collective processing target is changed to “ABORTED”, the collective aborting is completed.

Note that, for the communications between the transaction management computer 1 and the shop computers 2, the HTTP or any other suitable protocol may be used. In the case of using the HTTP, it is possible to use the implementation in which the PREPARE message and the PRECOMMIT message correspond to the request and reply of the HTTP, or the implementation in which the PREPARE message and the PRECOMMIT message are both transmitted as different requests of the HTTP. Note that it is preferable to provide higher security for the communications between the transaction management computer 1 and the shop computer 2 by using the authentication or the other measure according to the need.

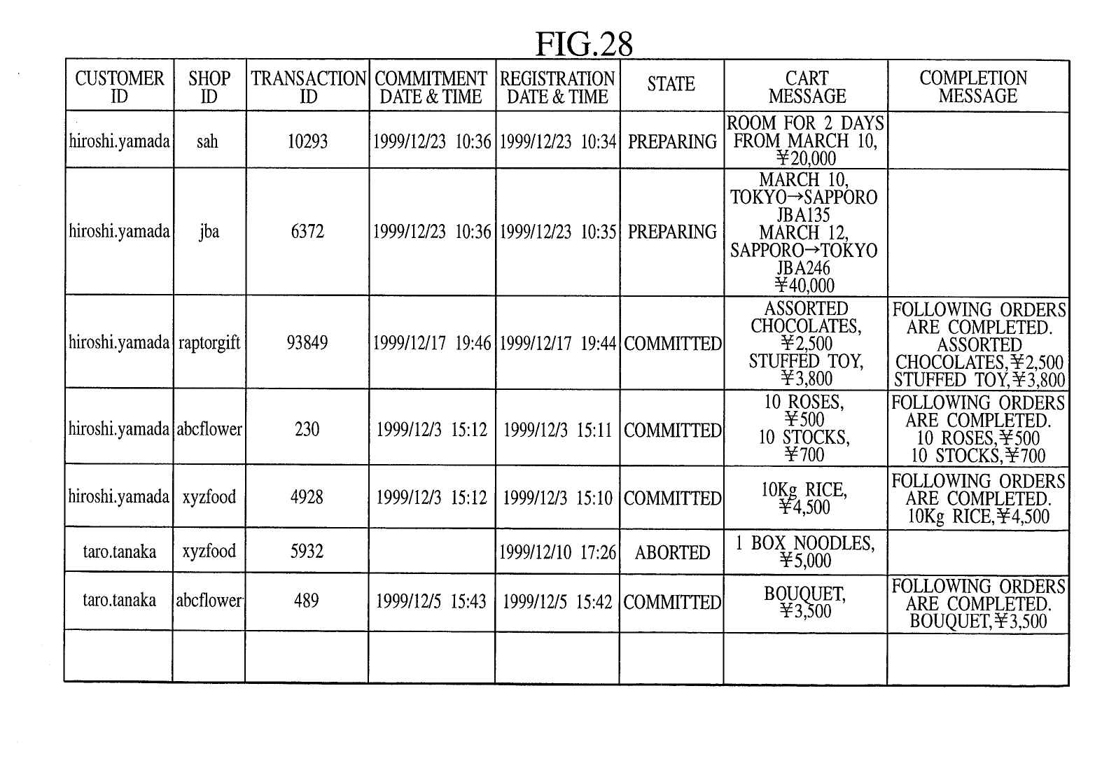

Now, the transaction management computer 1 that has retrieved the transaction information for which the value of the state field is “ACTIVE” from the transaction information database 13 first changes the value of the state field of the transaction information that is the collective processing target to “PREPARING”, and records the current date and time into the commitment date and time field ([60] of FIG. 26). Here, the current date and time are recorded in the commitment date and time field as these will be used for the time-out judgement in order to cancel those transactions for which the processing does not proceed over a prescribed period of time during the collective processing, as will be described below. As a result, the content of the transaction information database 13 becomes as shown in FIG. 28.

Then, the PREPARE message having the transaction ID of each transaction is sent to the shop computer 2 that carried out that transaction, with respect to all the transaction information that is the collective processing target ([61], [62] of FIG. 26). Here, in order to determine the destination of the PREPARE message, there is a need to find out the corresponding shop computer 2 from the shop ID recorded in the transaction information database 13. In this embodiment, it is assumed that the transaction management program 11 on the transaction management computer 1 has a correspondence table between the shop IDs and (URLs or the like of) the corresponding shop computers 2 that is provided in advance.

Each of the shop computers 2 that received the PREPARE message retrieves the transaction information of the transaction ID specified in the message from its database, and checks whether it is possible to complete the procedure to validate that transaction or not (that is, whether it is possible to finalize the completion of that transaction or the completion of that transaction is impossible for some reason) ([63], [64] of FIG. 26). If it is possible to complete, the shop computer 2 returns the PRECOMMIT message having the transaction ID to the transaction management computer 1 ([65], [66] of FIG. 26).

Upon receiving the PRECOMMIT message, the transaction management computer 1 changes the state of that transaction from “PREPARING” to “PRECOMMITTED”. When the state of all the transactions that are the collective processing target becomes “PRECOMMITTED”, it is confirmed that the completion of all these transactions can be finalized, so that the state of these transactions is changed from “PRECOMMITTED” to “COMMITTING”, the current date and time are recorded into the commitment date and time field ([67] of FIG. 26), and the COMMIT message having the transaction ID of the corresponding transaction is sent to each of the shop computers that are involved in these transactions, to command the completion of the procedure for that transaction (that is the execution of the processing for finalizing the completion of that transaction) ([68], [69] of FIG. 26.

At this point, in this embodiment, the personal information of the user (the name of the user as well as the delivery address, the telephone number, the account number for withdrawing the price, etc.) that is necessary for the processing at that site is also attached to the COMMIT message. In this case, the personal information items to be transmitted can be registered for each site in advance and only the necessary items can be transmitted, or the identical personal information can be transmitted to all the sites without carrying out the separate management for each site. The personal information of the user may be attached to the PREPARE message rather than the COMMIT message.

Note that this embodiment is directed to the case where the payment processing using the specified account or the credit card is carried out by the electronic shop side, but it is also possible to carry out the entire payment processing at the transaction management service provider side (transaction management computer 1 side) on behalf of all the electronic shops or only the prescribed electronic shops.

Upon receiving the COMMIT message, each shop computer 2 retrieves the transaction information of the transaction ID specified in the message from its database, and carries out the processing necessary at that site for finalizing the completion of the transaction by using the personal information of the user that is sent along with the COMMIT message ([70], [71] of FIG. 26). When this processing is completed, the COMMITTED message having the transaction ID is returned to the transaction management computer 1 ([72], [73] of FIG. 26). At this point, in this embodiment, the completion message is attached to the COMMITTED message. The completion message is a message to be given from the electronic shop to the user at a time of the completion of the transaction.

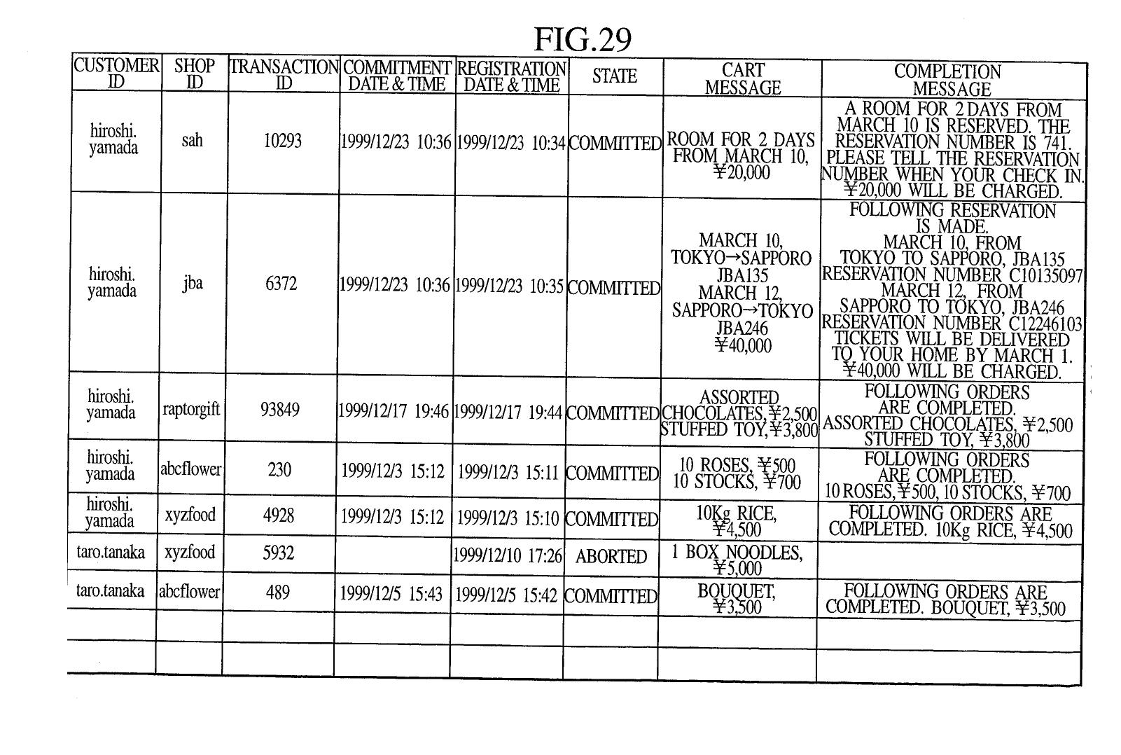

Upon receiving the COMMITTED message, the transaction management computer 1 changes the state of the corresponding transaction information from “COMMITTING” to “COMMITTED”, and records the current date and time into the commitment date and time ([74] of FIG. 26). At this point, the completion message sent along with the COMMITTED message is recorded into the completion message field of the corresponding transaction in the transaction information database 13. When the state of all the transactions which are the collective processing target becomes “COMMITTED”, all the procedures are completed, so that the completion notice page for the user is returned to the client computer 3 ([75] of FIG. 26). At this point, the content of the transaction information database 13 managed by the transaction management computer 1 is as shown in FIG. 29. In this embodiment, the completion message sent from the shop computer 2 that processed the corresponding transaction is embedded into the completion notice page.

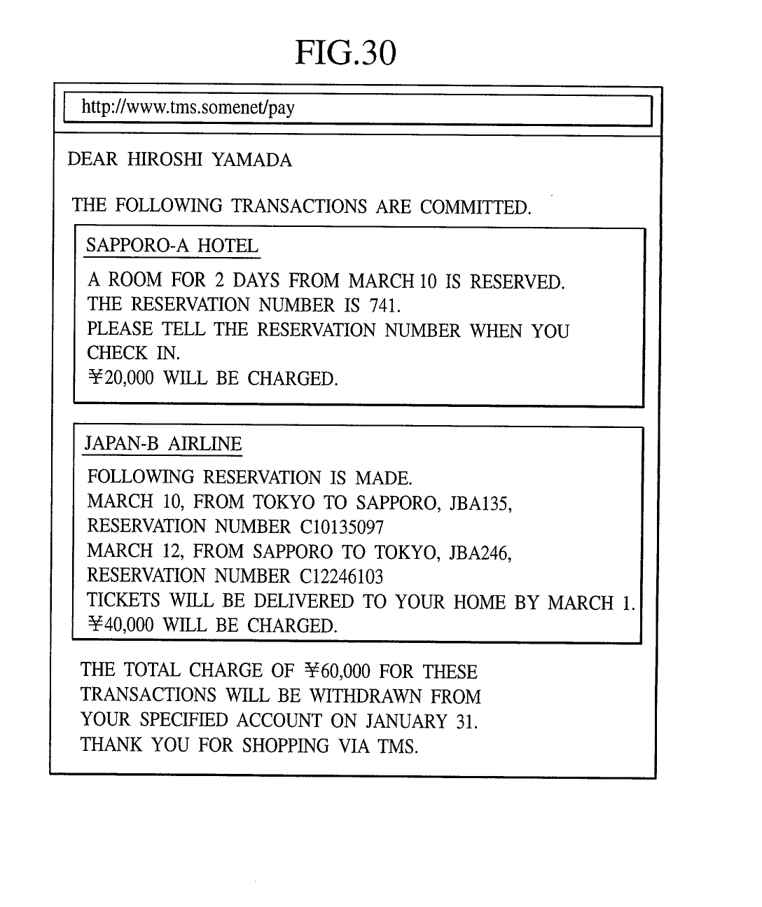

When this completion notice page with the completion message embedded therein is received at the client computer 3 of the user, this completion notice page is displayed at the WEB browser as shown in FIG. 30, for example.

The exemplary processing shown in FIG. 26 is for the normal case where all the shop computers 2 returns the PRECOMMIT messages in response to the PREPARE messages sent from the transaction management computer 1 to the shop computers 2. In the abnormal case, some shop computer 2 returns the ABORTED message rather than the PRECOMMIT message. In this case, the transaction management computer 1 can abort all the transactions that have returned the PRECOMMIT messages as described above. Alternatively, it is also possible to continue the commit processing for those transactions that have returned the PRECOMMIT messages without aborting them so as to complete the procedure for them (finalize the completion of these transactions). It is also possible to inquire the user as to whether all the transactions should be aborted, only those transactions that can be completed should be completed, or only selected transactions that can be completed as specified by the user should be completed, so as to allow the user to make the appropriate selection.

In this embodiment, the buttons for finalizing completion or failure of the individual transaction separately are also provided besides the buttons for finalizing completion or failure of all the transactions in the shopping cart atomically. It is also possible to use various other commitment methods. For example, it is also possible to provide a method for completing all the transactions in the shopping cart that can be completed and aborting the others that cannot be completed, and allow the user to select the way of finalizing completion or failure of the transactions. It is also possible to use the combinations of these methods.

It is also possible to use the grouping among a plurality of transactions in the shopping cart in units of one or a plurality of transactions to be collectively processed. In addition, it is also possible to command the collective processing by specifying one or a plurality of groups to be collectively processed.

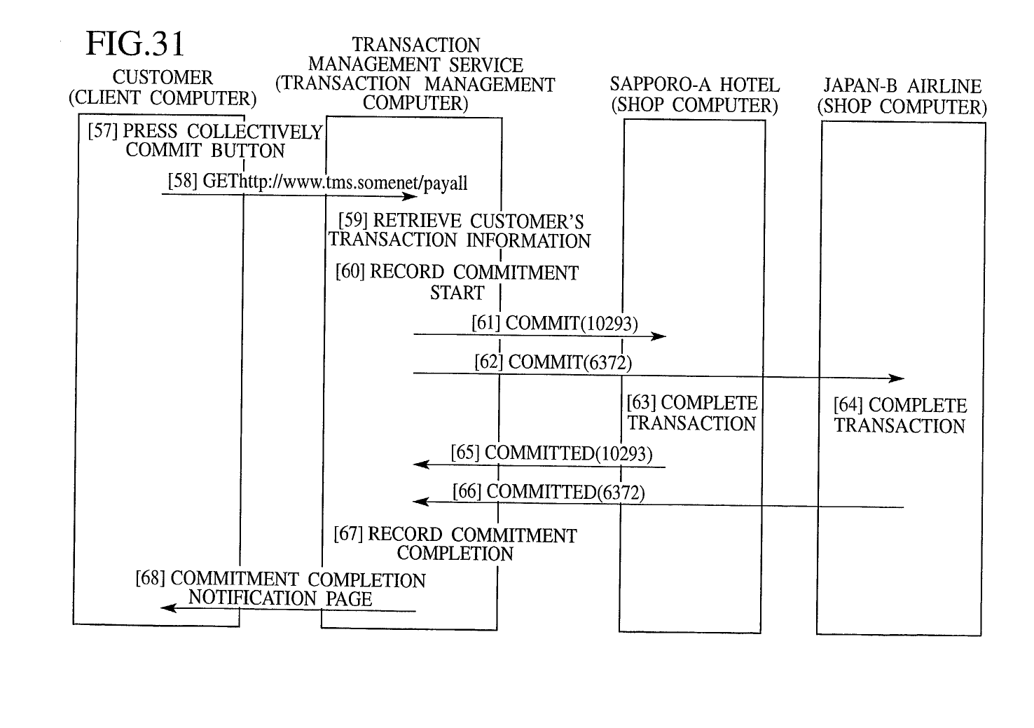

The exemplary processing shown in FIG. 26 is directed to the case where the transaction management computer 1 finalizes completion or failure of a plurality of transactions atomically by using the two-phase commit protocol that is widely in use, but it is also possible to realize the transaction management computer 1 that uses the one-phase commit protocol instead of the two-phase commit protocol. The exemplary collective processing in this case is shown in FIG. 31.

In this case, when the user presses the “Collectively commit” button on the shopping cart display screen of FIG. 25 ([57] of FIG. 31), a GET request for commanding the collective processing is sent from the client computer 3 to the transaction management computer 1 ([58] of FIG. 31).

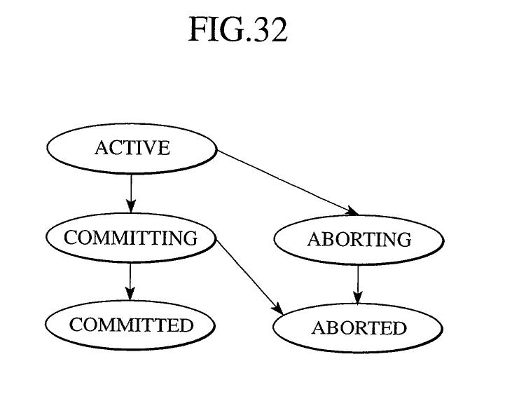

Next, the transaction management computer 1 retrieves the transaction information of the user for which the value of the state field is “ACTIVE” from the transaction information database 13 as the collective processing target by using the already authenticated customer ID ([59] of FIG. 31), and carries out the processing for finalizing these transactions according to the state transition shown in FIG. 32, interactively with the shop computer 2.

The state transition of FIG. 32 represents a one-phase commit protocol version of the state transition of FIG. 27.

The transaction information newly registered from the shop computer 2 is first entered into the transaction information database 13 in the “ACTIVE” state. Normally, when the collective processing is commanded by the user (by pressing the “Collectively commit” button, for example), the state of all the transactions in the “ACTIVE” state that are collective processing target is changed to “COMMITTING”, and a COMMIT message is sent to each corresponding shop computer 2 to command the completion of the procedure for the corresponding transaction (that is, the execution of the processing for finalizing completion of the corresponding transaction). The shop computer 2 returns a COMMITTED message when the processing necessary for finalizing completion of the corresponding transaction is finished at that site, so that the state of that transaction is changed to “COMMITTED”.

Here, upon receiving the COMMITTED message, if the completion of the procedure for the transaction is not possible (when the completion of the transaction is not possible for some reason), the shop computer 2 carries out the processing for aborting that transaction and returns an ABORTED message, so that the state of that transaction is changed to “ABORTED”.

Note that, in the case where the separate processing is commanded from the user (by pressing the “Separately commit” button, for example), this one-phase commit processing is carried out only with respect to the specified transaction.

In the case where the user himself/herself voluntarily aborts the transaction (by pressing the “Collectively abort” button or the “Separately abort” button in the shopping cart page, for example) or in the case where the transaction management computer 1 adopts a configuration for judging whether or not the transaction is to be aborted according to prescribed criteria automatically, the state of the transaction to be aborted is changed from “ACTIVE” to “ABORTING”, and the ABORT message is sent to the shop computer 2. When the ABORTED message is returned from the shop computer 2 which completed the aborting of the corresponding transaction, the state of that transaction is changed to “ABORTED”. In the case of the collective aborting, when the state of all the transactions that are the collective processing target is changed to “ABORTED”, the collective aborting is completed.

Now, the transaction management computer 1 that has retrieved the transaction information for which the value of the state field is “ACTIVE” from the transaction information database 13 first changes the value of the state field of the transaction information that is the collective processing target from “ACTIVE” to “COMMITTING”, and records the current date and time into the commitment date and time field ([60] of FIG. 31).

Then, the COMMIT message having the transaction ID of one of these transaction transactions is sent to the corresponding shop computer 2 to command the completion of the procedure for the corresponding transaction (that is, the execution of the processing for finalizing completion of the corresponding transaction) ([61], [62] of FIG. 31). At this point, in this embodiment, the necessary personal information of the user is also attached to the COMMIT message, similarly as in the case of the two-phase commit protocol.

Upon receiving the COMMIT message, each shop computer 2 retrieves the transaction information of the transaction ID specified in the message from its database, and carries out the processing necessary at that site for finalizing the completion of the transaction by using the personal information of the user that is sent along with the COMMIT message ([63], [64] of FIG. 31). When this processing is completed, the COMMITTED message having the transaction ID is returned to the transaction management computer 1 ([65], [66] of FIG. 31). At this point, in this embodiment, the completion message is attached to the COMMITTED message.

Upon receiving the COMMITTED message, the transaction management computer 1 changes the state of the corresponding transaction information from “COMMITTING” to “COMMITTED”, and records the current date and time into the commitment date and time ([67] of FIG. 31). At this point, the completion message sent along with the COMMITTED message is recorded into the completion message field of the corresponding transaction in the transaction information database 13. When the state of all the transactions which are the collective processing target becomes “COMMITTED”, all the procedures are completed, so that the completion notice page for the user is returned to the client computer 3 ([68] of FIG. 31).

When this completion notice page with the completion message embedded therein is received at the client computer 3 of the user, this completion notice page is displayed at the WEB browser as shown in FIG. 30, for example, similarly as in the case of the two-phase commit protocol.

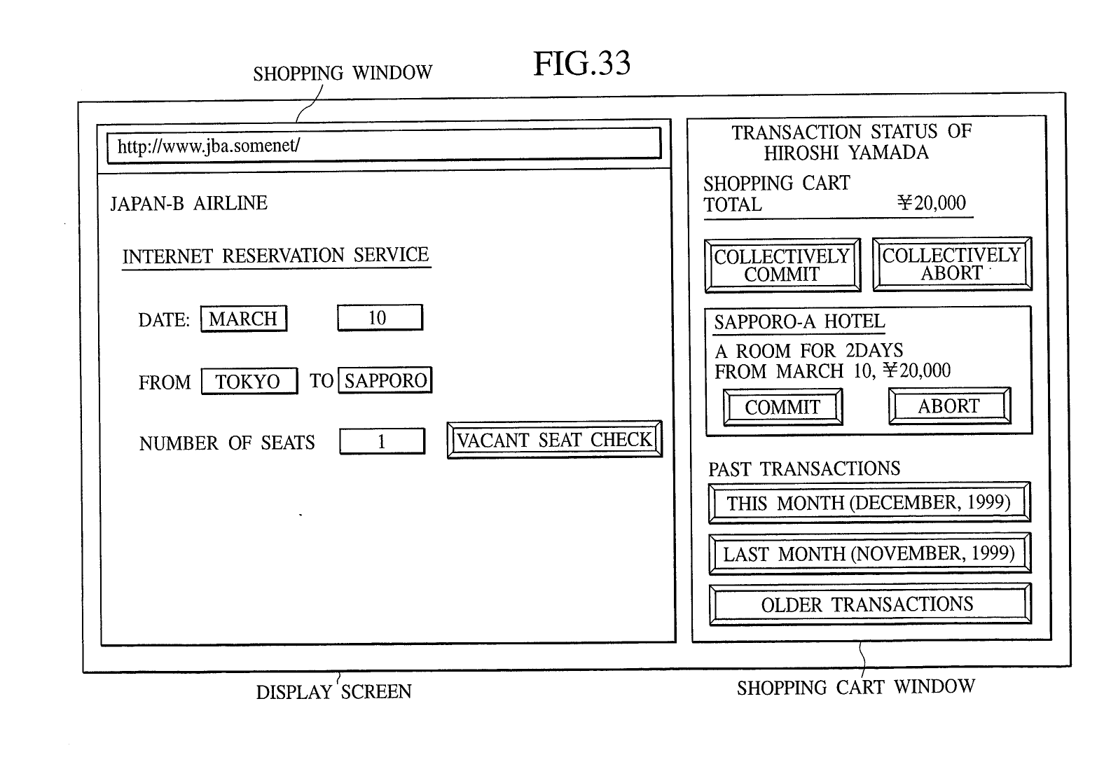

The embodiment described so far is directed to the case where the user who receives the electronic shop service by utilizing the transaction management service is interconnected with the shop computer 2 and the transaction management computer 1 by using the WEB browser, i.e., by carrying out operations for viewing, inputting and commanding on the electronic shop page display screen and the shopping cart page display screen that are displayed alternately, in order to carry out the processing for the transaction. Alternatively, it is also possible to carry out the processing for the transaction by simultaneously displaying a shopping window connected to the shop computer 2 and a shopping cart window connected to the transaction management computer 1 as shown in FIG. 33. In this way, the current content of the shopping cart is always visible so that it is convenient as it becomes possible to prevent the user from forgetting the need to finalize completion or failure of the transactions held in the shopping cart.

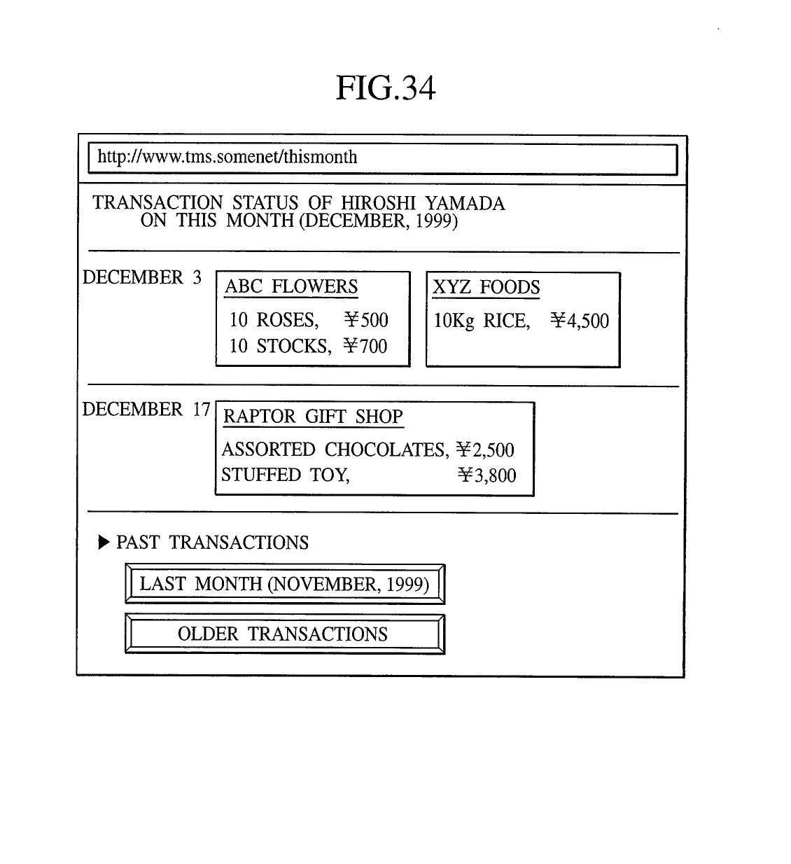

In this embodiment, the information on those transactions that were completed in the past by using the shopping cart of the transaction management computer 1 is also recorded in the transaction information database 13 of the transaction management computer 1. By enabling the user to view his/her own past transaction logs by accessing the transaction management computer 1, it becomes possible for the user to utilize the transaction management computer 1 as a personal transaction log record. This function can be realized such that, when the “This month (December, 1999)” button is pressed in the personal shipping cart page shown in FIG. 25, for example, the transaction log of that month is displayed as shown in FIG. 34. In addition, it is also possible to modify the example shown in FIG. 34 such that, when a “RAPTOR gift shop” information of December 17 is clicked using a pointing device such as mouse, for example, the user can access the shop computer 2 of the “RAPTOR gift shop” that carried out that transaction and inquire more detailed information regarding that transaction (such as a delivery status, for example).

The transaction information database 13 of the transaction management computer 1 stores permanent data to be managed by the database management system, which are unaffected even when a fault occurs at the client computer 3 or the shop computer 2. For this reason, when the user encounters a fault in a middle of the transaction as in the case where a fault occurs at the client computer 3 in a middle of the transaction and the client computer 3 is to be re-activated or another client computer 3 is to be used, or in the case where a fault occurs at the shop computer 2 or the network such that no response to the request from the client computer 3 is returned, the user can continue the transaction by re-accessing the transaction management computer 1.

For example, when a fault occurs at the client computer 3 after carrying out the transactions as shown in FIG. 4 and FIG. 15 and before commanding the start of the collective processing procedure of FIG. 26 (before the transmitted page of FIG. 25 is received, or before the received page is displayed, or before the “Collectively commit” button is pressed by the user on the displayed page, for example), the user can re-activate the client computer 3 and re-access the transaction management computer 1. Then, the shopping cart page in the same state as in FIG. 25 will be displayed after the user authentication using the customer ID is done, for example.

Here, the information on the transaction that was in progress before the occurrence of the fault at the client computer 3 remains valid in the transaction management computer 1 (the transaction information in the “ACTIVE” state is still registered as valid in the transaction information database 13 of the transaction management computer 1), so that it is possible to resume and continue the processing (for pressing the “Collectively commit” button, for example) from this page.

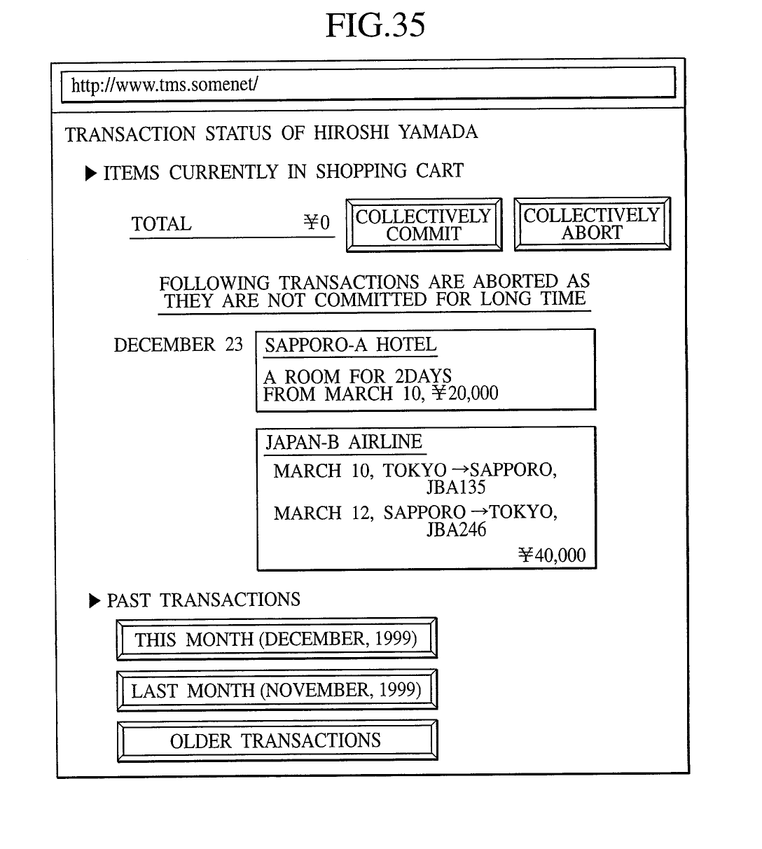

Here, the problem might arise if the repair of the client computer 3 is needed and the transaction management computer 1 is re-accessed only after several days such that the transaction in progress is left unchanged for long time. For this reason, the transaction management computer 1 may be provided with a function for forcefully cancelling the transaction that is not yet finalized and left unchanged over a prescribed period of time in the shopping cart. In such a case, the cancellation of the transaction may be notified to the client computer 3 at a time of re-access, as shown in FIG. 35, for example.

Even in the case where a fault occurs at the client computer 3 after the request from the client computer 3 to the transaction management computer 1 is sent as the user pressed the “Collectively commit” button, the “Separately commit” button, the “Collectively abort” button or the “Separately abort” button in order to finalize completion or failure of some or all of the transactions held in the shopping cart and before the final result is received from the transaction management computer 1, the final result can be checked by re-accessing the transaction management computer 1 similarly.

In this case, the fact that the user issued a command such as the collectively processing request is recorded in the transaction management computer 1 as the state field indication in the transaction information database 13, so that the transaction management computer 1 can proceed with the processing independently, regardless of the status of the client computer 3. Here, the completion message is preserved in the transaction information database 13. Consequently, even if the completion notice page cannot be returned to the client computer 3 at this point as the fault occurred at the client computer 3, it is possible to notify the result by transmitting the completion notice page containing the completion message to the user after the client computer 3 re-accesses the transaction management computer 1.

In the following, the exemplary operations of the transaction management program 11 to be operated on the transaction management computer 1 of this embodiment will be described in detail using flow charts.

The operation of the transaction management program 11 generally comprises the following four processings:

(1) a processing with respect to the shopping cart page request from the client computer 3;

(2) a processing with respect to the collective processing request from the client computer 3;

(3) a processing with respect to the aborting request from the client computer 3; and

(4) a fault recovery processing.

Each one of these four processings will now be described in detail.

(1) A processing with respect to the shopping cart page request from the client computer 3:

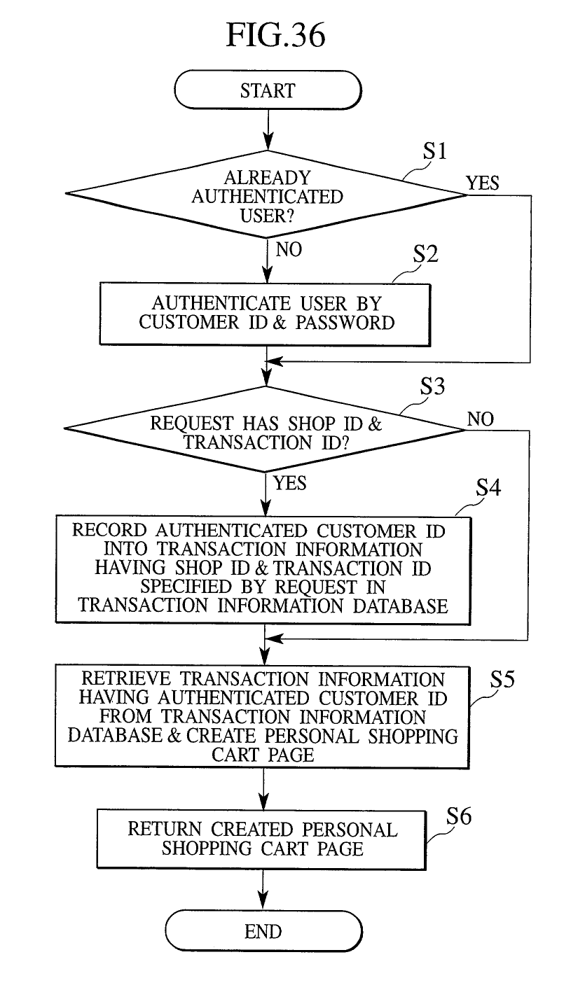

The processing flow in the case where the user accesses the transaction management computer 1 from the client computer 3 and requests the shopping cart page is as shown in FIG. 36.

First, whether it is an access from the user who is already authenticated or not is checked (step S1 of FIG. 36), and if not, the user is authenticated by urging the user to enter the customer ID and the password (step S2 of FIG. 36).

Next, whether the request has the shop ID and the transaction ID or not is checked (step S3 of FIG. 36). The client computer 3 requests the shopping cart page to the transaction management computer 1 in two cases including the case where the client computer 3 is re-directed from the shop computer 2 and the case where the client computer 3 voluntarily re-accesses after the fault or for the purpose of viewing the past transaction logs. In the former case, the request has the shop ID and the transaction ID so that the search through the transaction database 13 is , carried out by using the shop ID and the transaction ID, and the authenticated customer ID is recorded into the customer ID field of the transaction information found by the search (step S4 of FIG. 36).

Then, the transaction information of that user is retrieved from the transaction information database 13 by using the authenticated customer ID, and the personal shopping cart page for this user is created (step S5 of FIG. 36). Then, the created personal shopping cart page is returned to the client computer 3 (step S6 of FIG. 36).

By this processing, it becomes possible to always present the latest shopping cart information to the user in the case where the client computer 3 is re-directed from the shop computer 2 as well as in the case where the client computer 3 voluntarily re-accesses.

(2) A processing with respect to the collective processing request from the client computer 3:

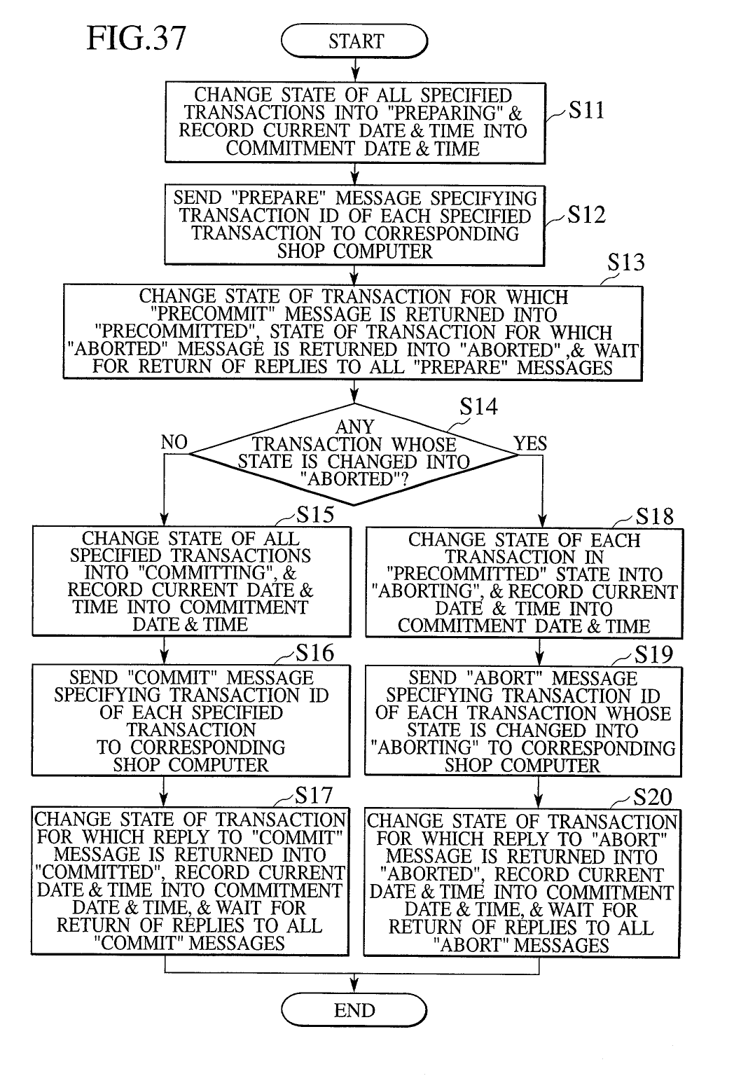

The processing flow in the case where the user accesses the transaction management computer 1 from the client computer 3 and requests the collective processing for the transactions in the shopping cart (by pressing the “Collectively commit” button, for example) is as shown in FIG. 37. In this case, the authentication is also carried out according to the need, but here it is assumed that the authentication is already done so that the authentication is omitted.

First, at the transaction information database 13, the state of all the transactions specified by the user as the collective processing target is changed to “PREPARING” and the current date and time are recorded into the commitment date and time field (step S11 of FIG. 37).

Next, the PREPARE message with the transaction ID specified therein is sent to each of the shop computers 2 involved in each of the transactions specified as the collective processing target (step S12 of FIG. 37). When the PRECOMMIT message is returned in response to the PREPARE message, the state of the corresponding transaction is changed to “PRECOMMITTED”, whereas when the ABORTED message is returned in response to the PREPARE message, the state of the corresponding transaction is changed to “ABORTED”, and the return of the replies to all the PREPARE messages is waited (step S13 of FIG. 37).

When the replies to all the PREPARE messages are returned and the ABORTED message is included among them so that there is a transaction whose state became “ABORTED, the operation proceeds to the step S18 so as to carry out the processing for aborting all the transactions, whereas otherwise the operation proceeds to the step S15 so as to carry out the processing for finalizing completion of all the transactions (step S14 of FIG. 37).

In the processing for finalizing completion of the transactions, first, the state of all the transactions specified as the collective processing target is changed to “COMMITTING” and the current date and time are recorded into the commitment date and time field (step S15 of FIG. 37). Next, the COMMIT message with the transaction ID specified therein is sent to each of the shop computers 2 involved in each of the transactions specified as the collective processing target (step S16 of FIG. 37). Then, with respect to each transaction for which the reply to the COMMIT message is returned, the state is changed to “COMMITTED” and the current date and time are recorded into the commitment date and time field, and the return of the replies to all the COMMIT messages is waited (step S17 of FIG. 37).

In the processing for aborting all the transactions, first, the state of all the transactions that are specified to be aborted and in the “PRECOMMITTED” state is changed to “ABORTING” and the current date and time are recorded into the commitment date and time field (step S18 of FIG. 37). Next, the ABORT message with the transaction ID specified therein is sent to each of the shop computers 2 involved in each of the transactions in the “ABORTING” state (step S19 of FIG. 37). Then, with respect to each transaction for which the reply-to the ABORT message is returned, the state is changed to “ABORTED” and the current date and time are recorded into the commitment date and time field, and the return of the replies to all the ABORT messages is waited (step S20 of FIG. 37).

Note that, in each waiting state described above, the processing is finished when all the necessary replies are returned, but if there is a reply that does not come back, the finishing of the processing is attempted by carrying out the fault recovery processing to be described below. The same remark also applies to each waiting state described below.

(3) A processing with respect to the aborting request from the client computer 3:

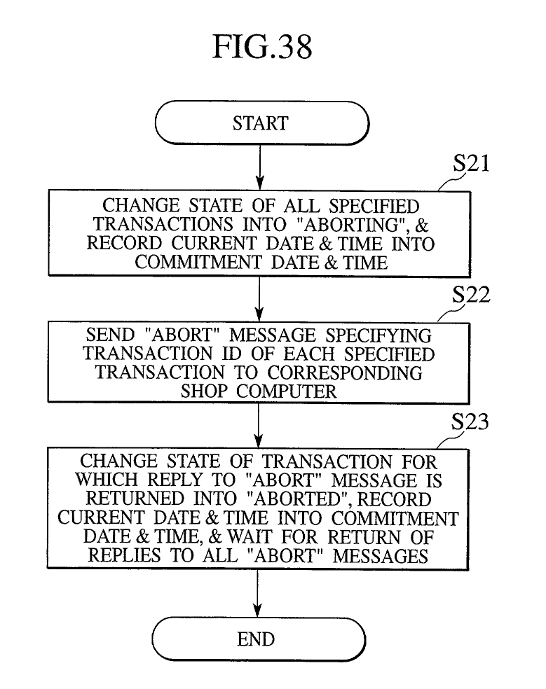

The processing flow in the case where the user accesses the transaction management computer 1 from the client computer 3 and requests the aborting of the transactions in the shopping cart (by pressing the “Collectively abort” button, for example) is as shown in FIG. 38. In this case, the authentication is also carried out according to the need, but here it is assumed that the authentication is already done so that the authentication is omitted.

In the processing for aborting the transactions, first, the state of all the transactions that are specified to be aborted is changed to “ABORTING” and the current date and time are recorded into the commitment date and time field (step S21 of FIG. 38). Next, the ABORT message with the transaction ID specified therein is sent to each of the shop computers 2 involved in each of the transactions that are specified to be aborted (step S22 of FIG. 38). Then, with respect to each transaction for which the reply to the ABORT message is returned, the state is changed to “ABORTED” and the current date and time are recorded into the commitment date and time field, and the return of the replies to all the ABORT messages is waited (step S23 of FIG. 38).

(4) A fault recovery processing:

In this embodiment, the transaction management computer 1 regularly monitors the transaction information database 13 and carries out the necessary fault recovery processing in order to deal with a fault of the shop computer 2 or a fault of the network.

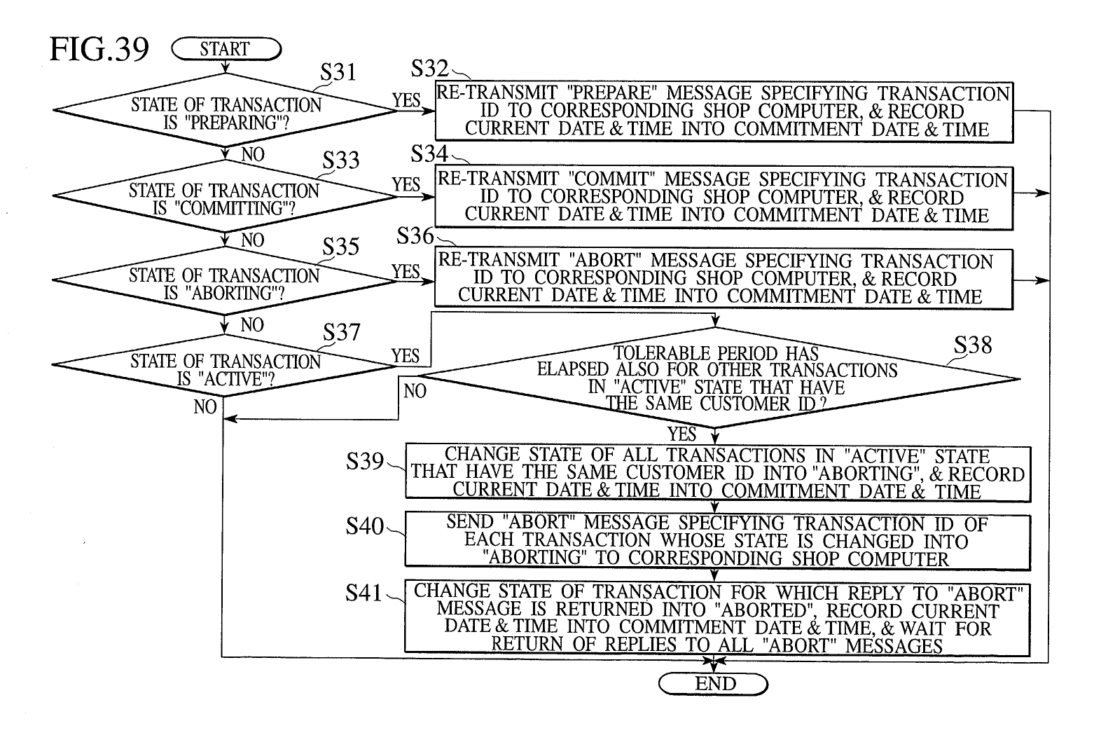

When there is a transaction information in the transaction information database 13 which is remaining in the “ACTIVE” state, the “PREPARING” state, the “COMMITTING” state, or the “ABORTING” state over a prescribed tolerable period of time, there is a possibility for a fault to have occurred, so that the fault recovery processing is carried out according to the procedure shown in FIG. 39.

Here, the date and time at which the state was changed in the transaction information database 13 are recorded in the commitment date and time field, so that whether the prescribed tolerable period of time has elapsed or not can be judged by comparing these date and time with the current date and time.

First, in the case where the state of the transaction is “PREPARING” (step S31 of FIG. 39), a reply to the PREPARE message has failed to come back, so that the PREPARE message with the transaction ID specified therein is re-transmitted to the shop computer 2 that has processed that transaction, and the current date and time are recorded into the commitment date and time field (step S32 of FIG. 39).

In the case where the state of the transaction is “COMMITTING” (step S33 of FIG. 39), a reply to the COMMIT message has failed to come back, so that the COMMIT message with the transaction ID specified therein is re-transmitted to the shop computer 2 that has processed that transaction, and the current date and time are recorded into the commitment date and time field (step S34 of FIG. 39).

In the case where the state of the transaction is “ABORTING” (step S35 of FIG. 39), a reply to the ABORT message has failed to come back, so that the ABORT message with the transaction ID specified therein is re-transmitted to the shop computer 2 that has processed that transaction, and the current date and time are recorded into the commitment date and time field (step S36 of FIG. 39).

Note that when the re-transmission is carried out once or a prescribed number of times, the fact that it is in a process of the re-transmission may be notified to the user through the WEB browser of the client computer 3, either in a form of simply notifying this fact or in a form where a notification of this fact is accompanied by some other information such as the name of the electronic shop with respect to which the re-transmission is carried out.

In the case where the state of the transaction is “ACTIVE” (step S37 of FIG. 39), whether or not the tolerable period of time has elapsed without the state change also for the other transactions in the “ACTIVE” state that have the same customer ID is checked (step S38 of FIG. 39). This is a check for preventing the erroneous cancellation of all the transactions due to the earlier transaction, that could have occurred without this check in the case where the user holds a plurality of transactions in the shopping cart and a significant amount of time has elapsed since the state is changed to “ACTIVE” for the transaction that was put into the shopping cart first but the state is changed to “ACTIVE” only short time ago for the transaction that was put into the shopping cart last.

When the tolerable period of time has elapsed for all the transactions in the “ACTIVE” state that have the same customer ID, it is regarded that the user has no intention to complete these transactions so that the operation proceeds to the step S39 so as to carry out the processing for forcefully cancelling these transactions.

In the processing for forcefully cancelling the transactions, first, the state of all the transactions in the “ACTIVE” state that have the same customer ID is changed to “ABORTING” and the current date and time are recorded into the commitment date and time field (step S39 of FIG. 39). Next, the ABORT message with the transaction ID specified therein is sent to each of the shop computers 2 involved in each of the transactions whose state has been changed to “ABORTING” (step S40 of FIG. 39). Then, with respect to each transaction for which the reply to the ABORT message is returned, the state is changed to “ABORTED” and the current date and time are recorded into the commitment date and time field, and the return of the replies to all the ABORT messages is waited (step S41 of FIG. 39).

Note that, when the state in which the reply fails to come back continues even after the re-transmission of each message described above, the processing for forcefully cancelling these transactions may be carried out by judging that the fault has occurred, if a prescribed condition holds. Here, the prescribed condition can be a condition that the message has been re-transmitted for a prescribed number of times, a condition that a prescribed period of time has elapsed since the message is transmitted initially, or a condition that a time equivalent to the tolerable period of time for the “ACTIVE” state has elapsed since the registration of the transaction, for example.

The tolerable period of time to be used in judging the start of the fault recovery processing can be set by various methods. One method is to use a predetermined period of time (for example, five minutes, three hours, one day, etc.) as the tolerable period of time. It is also possible to set the tolerable period of time differently for different states of the transactions. For example, the tolerable period of time can be set to be one hour for the “ACTIVE” state, and 120 seconds for the “PREPARING” state, the “COMMITTING” state and the “ABORTING” state.

Another method is to set the tolerable period of time variably such that the tolerable period of time becomes longer for the user who utilizes the system more frequently, by referring to the past transaction logs of the user.

Still another method is that in which the shop computer 2 registers desired tolerable periods of time (in such a manner as specifying the tolerable period of time for a certain transaction content as two hours, for example) at a time of registering the transaction into the transaction management computer 1, and the transaction management computer 1 is operated to use the registered tolerable periods of time with respect to all the transactions.

It is also possible to operate the transaction management computer 1 to send a warning for urging the user related to that transaction to finalize completion or failure of the transaction soon, before the tolerable period of time elapses for the transaction in the “ACTIVE” state. This warning can be made by entering a warning message into the shopping cart page when the user requested the shopping cart page, or by giving a warning notice directly to the user by sending an e-mail or making a telephone call.

Also, the user may be alerted by presenting the tolerable period of time in the shopping cart page in advance.

In this embodiment, when the state is “PREPARING”, “COMMITTING” or “ABORTING”, even if the occurrence of the fault is recognized at the shop computer 2 side, the transaction management computer 1 is operated to wait until the time-out of the tolerable period of time and then carry out the re-transmission of the message. However, it is also possible to send a demanding message from the shop computer 2 side to the transaction management computer 1. In this case, upon receiving this demanding message, the transaction management computer 1 re-transmits the message that was transmitted immediately earlier in relation to the corresponding transaction.

As described, even if a network fault or the like occurs in a middle of the collective processing, the transaction management computer 1 will carry out the fault recovery processing so that the user can request the collective processing without any anxiety. Also, even if the user quits the operation in a middle despite of the fact that the transactions are held in the shopping cart, the transaction management computer 1 will carry out the processing for forcefully cancelling these transactions so that the electronic shop can carry out the processing necessary for the transaction (especially the tentative reservation over a prescribed period of time of the products or the like related to the transactions held in the shopping cart) without any anxiety.

In the following, the exemplary operations of the electronic shop program to be operated on the shop computer 2 of this embodiment will be described in detail using flow charts.

The operation of the electronic shop program generally comprises the following four processings:

(1) a processing with respect to the TMS registration request from the client computer 3;

(2) a processing with respect to the PREPARE processing request from the transaction management computer;

(3) a processing with respect to the COMMIT processing request from the transaction management computer; and

(4) a processing with respect to the ABORT processing request from the transaction management computer.

Each one of these four processings will now be described in detail.

(1) A processing with respect to the TMS registration request from the client computer 3:

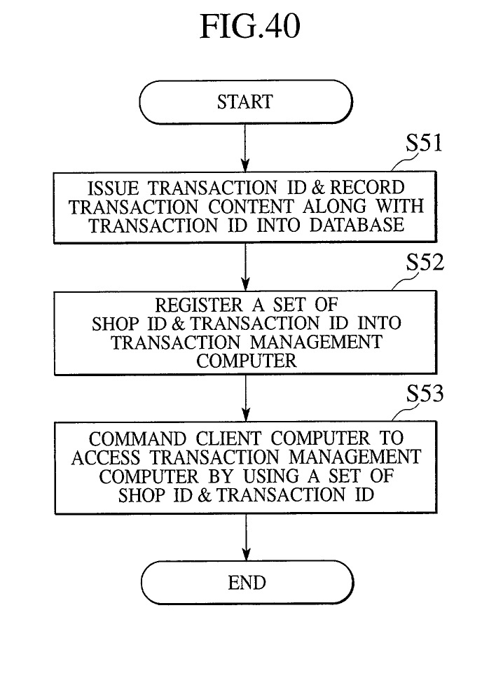

In the case where the request for the continuation of the processing for the transaction currently in progress is received from the client computer 3 of the user by utilizing the transaction management computer 1 (as the user pressed the “Reserve by TMS” button or the “Pay by TMS” button, for example), the shop computer 2 registers the transaction into the transaction management computer 1 according to the procedure shown in FIG. 40 as follows.

First, the shop computer 2 issues the transaction ID with respect to the current transaction, and stores the transaction content and the transaction ID in correspondence into a database managed by the shop computer 2 (step S51 of FIG. 40).

Next, the shop computer 2 sends a set of the shop ID assigned by the transaction management computer 1 to that electronic shop and the transaction ID to the transaction management computer 1, so as to register the set of the shop ID and the transaction ID at the transaction management computer 1 (step S52 of FIG. 40).

Finally, the shop computer 2 commands the client computer 3 to access the transaction computer 1 by using the set of the shop ID and the transaction ID in order to request the shopping cart page (step S53 of FIG. 40).

In this embodiment, the commanding of the client computer 3 to access the transaction management computer 1, is realized by using the re-direction function of the HTTP, although it is also possible to use the other scheme for this purpose.

In order to utilize the transaction management computer 1 (in order to utilize the shopping cart), it suffices to enter the transaction information given by the set of the customer ID, the shop ID and the transaction ID into the transaction information database 13 of the transaction management computer 1. To this end, it is also possible for the shop computer 2 to carry out the user authentication using the customer ID and directly register the set of the customer ID, the shop ID and the transaction ID into the transaction management computer 1.

(2) A processing with respect to the PREPARE processing request from the transaction management computer:

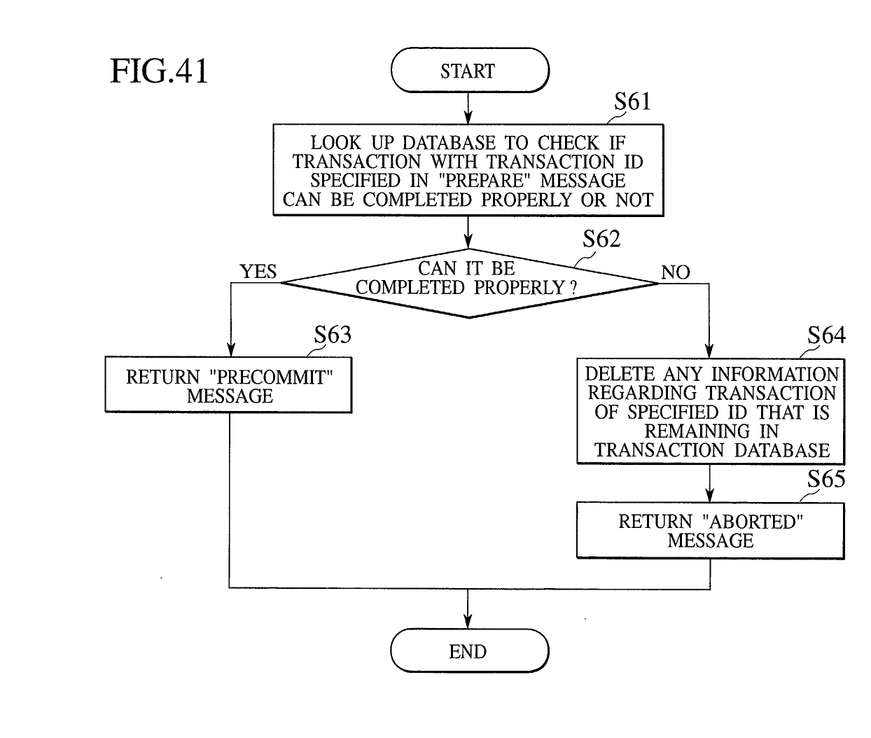

In the case where the shop computer 2 received the PREPARE message from the transaction management computer 1, the shop computer 2 carries out the processing according to the procedure shown in FIG. 41 as follows.

First, the search through the database is carried out by using the transaction ID specified in the PREPARE message, and whether the completion of the procedure for the corresponding transaction is possible or not (that is, whether the completion of the transaction is possible or not) is checked (step S61 of FIG. 41). If the completion is possible (step S62 of FIG. 41), the PRECOMMIT message is returned (step S63 of FIG. 41). According to the need, in order to guarantee that the completion is possible, it is also possible to carry out the necessary processing (such as the processing for recording the data regarding the transaction on the memory into the magnetic disk so that the data regarding the transaction will not be lost by the subsequent fault, for example) before returning the PRECOMMIT message.

When the completion of the procedure for the corresponding transaction is impossible for some reason (that is, when it is impossible to complete the transaction), any information related to the specified transaction ID that is remaining in the database is deleted (step S64 of FIG. 41), and the ABORTED message is returned (step S65 of FIG. 41).

(3) A processing with respect to the COMMIT processing request from the transaction management computer:

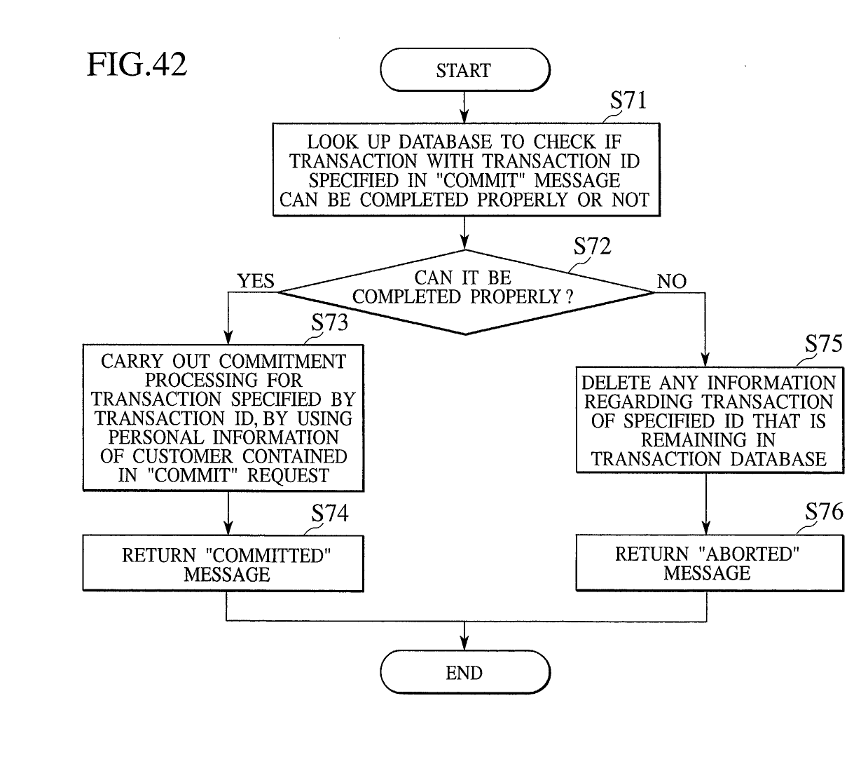

In the case where the shop computer 2 received the COMMIT message from the transaction management computer 1, the shop computer 2 carries out the processing according to the procedure shown in FIG. 42 as follows.

First, the search through the database is carried out by using the transaction ID specified in the COMMIT message, and whether the completion of the procedure for the corresponding transaction is possible or not is checked (step S71 of FIG. 42). If the completion is possible (step S72 of FIG. 42), the processing necessary in finalizing completion of the corresponding transaction is carried out by using the personal information of the user contained in the COMMIT message (step S73 of FIG. 42), and the COMMITTED message is returned (step S74 of FIG. 42). At this point, the completion notice message for notifying the completion of the procedure to the user is returned together.

When the completion of the procedure for the corresponding transaction is impossible for some reason, any information related to the specified transaction ID that is remaining in the database is deleted (step S75 of FIG. 42), and the ABORTED message is returned (step S76 of FIG. 42).

(4) A processing with respect to the ABORT processing request from the transaction management computer:

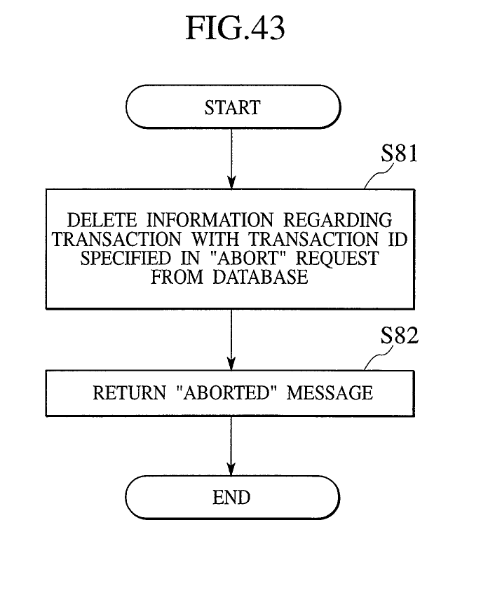

In the case where the shop computer 2 received the ABORT message from the transaction management computer 1, the shop computer 2 carries out the processing according to the procedure shown in FIG. 43 as follows.

First, any information related to the transaction ID specified in the ABORT message that is remaining in the database is deleted (step S81 of FIG. 43), and the ABORTED message is returned (step S82 of FIG. 43).

In the fault recovery processing of the transaction management program 11 on the transaction management computer 1, if the reply to the PREPARE message, the COMMIT message or the ABORT message fails to come back, there is a possibility that the message is lost on the network so that the fault recovery is carried out by re-transmitting the message. For this reason, the electronic shop program on the shop computer 2 needs to be prepared for the case where the PREPARE message, the COMMIT message, or the ABORT message is transmitted from the transaction management computer 1 for a plurality of times redundantly. Namely, even when the message is already received and the reply is already returned, if that reply is lost on the network, the transaction management computer 1 will re-transmit that message. In such a case, the shop computer 2 returns the same reply as that previously returned.

As described, according to the present invention, the transaction management computer manages transactions between the user and the electronic shops so that it becomes possible to detect the fault and recover from the fault or deal with the fault.

Also, according to the present invention, the transaction management computer manages transactions between the user and the electronic shops so that it is possible to realize the global shopping cart across a plurality of electronic shops.

Also, according to the present invention, the transaction management computer manages transactions between the user and the electronic shops so that it is possible to realize the centralized management of the past transaction logs across a plurality of electronic shops.

It is to be noted that the above described embodiment according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the transaction management computer of the above described embodiment can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiment may be made without departing from the novel and advantageous features of the present invention.

Accordingly, all such modifications and variations are intended to be included within the scope of the appended claims.

What is claimed is:

1. A transaction management device, connected through a network with a plurality of shop computers providing electronic shops on the network and a plurality of client computers used by users utilizing the electronic shops, the transaction management device comprising:
a management unit configured to manage transaction information for each transaction currently in progress between one electronic shop among the plurality of electronic shops and one user among the plurality of users, the transaction information containing a set of: a first information for identifying said each transaction; a second information for identifying said one user; a third information for identifying said one electronic shop; and a fourth information for indicating a state of said each transaction as one of a plurality of possible states including a first state in which a command for finalizing completion or failure of transaction is waited, a second state in which a command for finalizing completion of transaction is received and a processing for finalizing completion of transaction is started but not finished yet, a third state in which the processing for finalizing completion of transaction is finished, and a fourth state in which failure of transaction is already finalized; and
a processing unit configured to process said each transaction according to the transaction information managed by the management unit.

2. The transaction management device of claim 1, wherein the processing unit carries out a collective processing for finalizing completion or failure of a plurality of transactions collectively by carrying out a prescribed procedure with shop computers corresponding to the plurality of transactions, upon receiving a command for finalizing completion or failure of the plurality of transactions for which the transaction information has the fourth information indicating the first state, from a client computer.

3. The transaction management device of claim 2, wherein when a command for finalizing completion of the plurality of transactions is received, the processing unit inquires each shop computer corresponding to a transaction among the plurality of transactions as to whether the processing for finalizing completion of transaction can be completed for a corresponding transaction or not, commands said each shop computer to complete the processing for finalizing completion of transaction for the corresponding transaction when the processing for finalizing completion of transaction can be completed for all of the plurality of transactions, or commands said each shop computer to cancel the corresponding transaction such that all of the plurality of transactions are cancelled when the processing for finalizing completion of transaction cannot be completed for at least one of the plurality of transactions.

4. The transaction management device of claim 3, wherein the processing unit also notifies a personal information of a user related to the corresponding transaction at a time of commanding said each shop computer to complete the processing for finalizing completion of transaction for the corresponding transaction.

5. The transaction management device of claim 1, wherein the processing unit detects each transaction information for which the fourth information continues to indicate one state other than final states over a prescribed period of time or not, re-transmits a corresponding message when said one state is a state in which a reply to an already transmitted message is waited, and initializes a time for which the fourth information of said each transaction information continues to indicate said one state.

6. The transaction management device of claim 1, wherein the processing unit detects each transaction information for which the fourth information continues to indicate the first state over a prescribed period of time, and commands a shop computer corresponding to said each transaction information to cancel a corresponding transaction.

7. The transaction management device of claim 1, wherein when a client computer of a particular user re-accesses the transaction management device, the processing unit creates a notification information according to the state indicated by the fourth information of each transaction information which has the second information corresponding to the particular user and transmits the notification information to the client computer of the particular user.

8. The transaction management device of claim 1, wherein the management unit also manages each transaction information which has the fourth information indicating the third state as a past transaction log, and when a request for transmitting transaction logs satisfying a prescribed condition is received from a client computer of a particular user, the processing unit generates a transaction log information according to each transaction information that has the fourth information indicating the third state, that has the second information corresponding to the particular user, and that satisfies the prescribed condition, and transmits the transaction log information to the client computer of the particular user.

9. The transaction management device of claim 1, wherein the processing unit transmits the command for finalizing completion of transaction for a particular transaction information which has the fourth information indicating the first state as received from a client computer of a particular user related to the particular transaction information, to a shop computer of a particular electronic shop related to the particular transaction information, and
the processing unit transmits a notice of a completion of the processing for finalizing completion of transaction for the particular transaction information as received from the shop computer of the particular electronic shop, to the client computer of the particular user.

10. A method for realizing electronic commerce between a plurality of shop computers providing electronic shops on a network and a plurality of client computers used by users utilizing the electronic shops, comprising:
managing transaction information for each transaction currently in progress between one electronic shop among the plurality of electronic shops and one user among the plurality of users, at a transaction management computer, the transaction information containing a set of: a first information for identifying said each transaction; a second information for identifying said one user; a third information for identifying said one electronic shop; and a fourth information for indicating a state of said each transaction as one of a plurality of possible states including a first state in which a command for finalizing completion or failure of transaction is waited, a second state in which a command for finalizing completion of transaction is received and a processing for finalizing completion of transaction is started but not finished yet, a third state in which the processing for finalizing completion of transaction is finished, and a fourth state in which failure of transaction is already finalized; and
processing said each transaction according to the transaction information managed by the managing step, at the transaction management computer.

11. The method of claim 10, wherein the processing step carries out a collective processing for finalizing completion or failure of a plurality of transactions collectively by carrying out a prescribed procedure with shop computers corresponding to the plurality of transactions, upon receiving a command for finalizing completion or failure of the plurality of transactions for which the transaction information has the fourth information indicating the first state, from a client computer.

12. The method of claim 11, wherein when a command for finalizing completion of the plurality of transactions is received, the processing step inquires each shop computer corresponding to a transaction among the plurality of transactions as to whether the processing for finalizing completion of transaction can be completed for a corresponding transaction or not, commands said each shop computer to complete the processing for finalizing completion of transaction for the corresponding transaction when the processing for finalizing completion of transaction can be completed for all of the plurality of transactions, or commands said each shop computer to cancel the corresponding transaction such that all of the plurality of transactions are cancelled when the processing for finalizing completion of transaction cannot be completed for at least one of the plurality of transactions.

13. The method of claim 12, wherein the processing step also notifies a personal information of a user related to the corresponding transaction at a time of commanding said each shop computer to complete the processing for finalizing completion of transaction for the corresponding transaction.

14. The method of claim 10, wherein the processing step detects each transaction information for which the fourth information continues to indicate one state other than final states over a prescribed period of time or not, re-transmits a corresponding message when said one state is a state in which a reply to an already transmitted message is waited, and initializes a time for which the fourth information of said each transaction information continues to indicate said one state.

15. The method of claim 10, wherein the processing step detects each transaction information for which the fourth information continues to indicate the first state over a prescribed period of time, and commands a shop computer corresponding to said each transaction information to cancel a corresponding transaction.

16. The method of claim 10, wherein when a client computer of a particular user re-accesses the transaction management device, the processing step creates a notification information according to the state indicated by the fourth information of each transaction information which has the second information corresponding to the particular user and transmits the notification information to the client computer of the particular user.

17. The method of claim 10, wherein the managing step also manages each transaction information which has the fourth information indicating the third state as a past transaction log, and when a request for transmitting transaction logs satisfying a prescribed condition is received from a client computer of a particular user, the processing step generates a transaction log information according to each transaction information that has the fourth information indicating the third state, that has the second information corresponding to the particular user, and that satisfies the prescribed condition, and transmits the transaction log information to the client computer of the particular user.

18. The method of claim 10, wherein the managing step acquires any information that is constituting the transaction information and generated at a client computer of said one user or a shop computer of said one electronic shop, from the client computer of said one user through the shop computer of said one electronic shop.

19. The method of claim 10, wherein the processing step transmits the command for finalizing completion of transaction for a particular transaction information which has the fourth information indicating the first state as received from a client computer of a particular user related to the particular transaction information, to a shop computer of a particular electronic shop related to the particular transaction information, and
the processing step transmits a notice of a completion of the processing for finalizing completion of transaction for the particular transaction information as received from the shop computer of the particular electronic shop, to the client computer of the particular user.

20. A computer usable medium having computer readable program codes embodied therein for causing a computer to function as a transaction management computer, the computer readable program codes include:
a first computer readable program code for causing said computer to manage transaction information for each transaction currently in progress between one electronic shop among the plurality of electronic shops and one user among the plurality of users, the transaction information containing a set of: a first information for identifying said each transaction; a second information for identifying said one user; a third information for identifying said one electronic shop; and a fourth information for indicating a state of said each transaction as one of a plurality of possible states including a first state in which a command for finalizing completion or failure of transaction is waited, a second state in which a command for finalizing completion of transaction is received and a processing for finalizing completion of transaction is started but not finished yet, a third state in which the processing for finalizing completion of transaction is finished, and a fourth state in which failure of transaction is already finalized; and
a second computer readable program code for causing said computer to process said each transaction according to the transaction information managed by the first computer readable program code.
